(19) United States
(12) Patent Application Publication
(10) Pub. No.: US 2026/0118838 A1
(43) Pub. Date: Apr. 30, 2026

(54) GENERATION OF RECOVERY SCENARIOS FOR AUTONOMOUS AND SEMI-AUTONOMOUS MACHINES AND APPLICATIONS

(71) Applicant: NVIDIA CORPORATION, Santa Clara, CA (US)

(72) Inventors: Alexander A Popov, Kirkland, WA (US); Alperen Degirmenci, Jersey City, NJ (US); Nikolai Smolyanskiy, Seattle, WA (US); David Ambrose Wehr, Seattle, WA (US); Alexey Kamenev, Carlsbad, CA (US); Ryan Oldja, Issaquah, WA (US); David Per Zachris Nister, Bellevue, WA (US); Ruchita Bhargava, Redmond, WA (US); Urs Andrew Muller, Keyport, NJ (US)

(21) Appl. No.: 19/041,061

(22) Filed: Jan. 30, 2025

Related U.S. Application Data
(63) Continuation of application No. 19/041,044, filed on Jan. 30, 2025.
(60) Provisional application No. 63/675,196, filed on Jul. 24, 2024.

(51) Int. Cl. G05B 13/02

(52) U.S. Cl. CPC G05B 13/027

(57) ABSTRACT

In some embodiments, a generative DNN trained as part of a probabilistic state simulation stack may be sampled generatively to generate ground truth recovery scenarios for other navigation policies or other supervised DNNs (e.g., a neural planner) that were not part of the probabilistic state simulation stack. For example, an initial trajectory that drifts from an optimal or target trajectory may be generated (e.g., using a neural planner to control navigation of an ego-machine in a simulation environment or in a latent space of a probabilistic state simulation stack). As such, a control stack trained as part of a probabilistic state simulation stack may be used to recover from the initial trajectory, and the resulting recovery trajectory may be recorded and used to train a navigation policy or other supervised DNN such as a neural planner (e.g., the neural planner that generated the initial trajectory).

### CROSS-REFERENCE TO RELATED APPLICATIONS

This application is a continuation of U.S. application Ser. No. 19/041,044, filed on Jan. 30, 2025, which claims the benefit of U.S. Provisional Application No. 63/675,196, filed on Jul. 24, 2024, the contents of each of which are hereby incorporated by reference in their entirety.

### BACKGROUND

Many autonomous machines like self-driving cars and drones use a navigation (e.g., driving) policy to make decisions about how to behave in various (e.g., driving) scenarios in complex, real-world environments. Navigation policies are often implemented using neural motion planners (or neural planners)—advanced decision-making systems that use deep neural networks (DNNs) to determine the best actions, for example, based on the machine's current state and its surroundings. Some neural planners are trained using imitation learning, where they learn by observing and mimicking recorded behaviors of human experts (e.g., how a human driver navigates traffic or avoids obstacles). The neural planner generalizes from this data to make its own decisions.

However, during deployment, these models often face a challenge known as covariate shift, which occurs when the state distribution encountered by the neural planner's policy during training differs from what it encounters during deployment. This discrepancy arises because the training data—which represents recorded expert behavior or other target behavior—may not encompass all possible situations the neural planner might encounter in practice, such as unpredictable human behavior (e.g., pedestrians jaywalking, cyclists weaving between cars, vehicles making sudden illegal maneuvers). As a result, the neural planner may perform well in situations that were represented in its training data, but may generate random or incorrect drive actions in response to previously unseen situations during deployment. The discrepancy between the training and deployment environments can lead to compounding errors in which an autonomous vehicle drifts away from optimal trajectories when guided by the trained neural planners, exhibiting degraded performance and potentially unsafe or inefficient behavior.

Some conventional techniques attempt to address the covariate shift problem using simulated training data. Instead of using training data consisting solely of expert demonstrations performed under typical, safe driving conditions, these techniques use simulation environments or other tools to manually generate simulated training data representing potential edge cases, errors, and/or uncommon scenarios that the neural planner might encounter during deployment. For example, developers or domain experts may manually generate and expose the neural planner to simulated training data representing hard-crafted scenarios such as unusual road layouts, unexpected obstacles, sudden traffic changes, adverse weather, and other rare (long tail) situations that fall outside the typical scenarios seen during training. In practice, this hand-crafting of simulated data often involves adding perturbations to real data by adding noise. While training on this enriched dataset can help the neural planner to handle a broader spectrum of driving contexts, the process of manually hand-crafting simulation data is often error prone, does not represent traffic behaviors perfectly correctly, and as a result, often leads the neural planner to engage in unrealistic driving behaviors.

In the context of simulation, a gap or discrepancy between the simulated environment and real-world conditions can arise because even advanced simulators can struggle to accurately replicate the complexity, variability, and unpredictability of rare real-world scenarios. Factors contributing to this gap include limitations in the fidelity of the simulation models, differences in sensor inputs, and the challenge of capturing the full spectrum of environmental and behavioral nuances present in real-life driving. As a result, while a neural planner might perform well in simulated long tail cases, its performance in the real world may be less reliable if those rare situations are not perfectly mirrored in the simulator.

More generally, the accuracy of a navigation (e.g., driving) policy and the actions it chooses can depend on a variety of factors, including how accurately the surrounding environment is perceived and encoded into corresponding inputs for the policy. Conventional driving policies often rely on spatial representations of features of the surrounding environment detected from raw sensor data, such as occupancy maps representing detected road boundaries and obstacles. These encoded inputs may be applied to DNNs or rule-based systems that define the driving policy and determine which actions to take. The accuracy and richness of these encoded inputs directly influence the effectiveness and safety of the driving policy. Although perception techniques tend to improve over time, the current state of the art is limited in how accurately it perceives and encodes the real-world environment, and in the level of detail and comprehensiveness of the encoding. These limitations can lead to an incomplete or incorrect environmental understanding, which in turn impacts the driving policy. For example, if a perception system misinterprets important information or the resolution of the resulting encoding is inadequate, the driving policy may make suboptimal or unsafe decisions, such as misjudging when to brake or change lanes. More generally, other types of tasks that rely on perception can experience corresponding degradations in performance resulting from limitations in existing perception techniques.

As such, there is a need for improved techniques for perception, and determining which actions autonomous or semi-autonomous machines such as self-driving cars and drones should take.

### SUMMARY

Embodiments of the present disclosure relate to perception, scene encoding, probabilistic state simulation, and/or generation of (e.g., ground truth) recovery scenarios for autonomous machines and applications.

In some embodiments, a probabilistic state simulation stack may be used to estimate and represent the state of a scene, including the state of an ego-machine (e.g., speed or position), traffic dynamics (e.g., the behavior of other road users), and/or static elements in the environment (e.g., roads, signs, or obstacles). Co-training a driving (or other navigation) policy as part of a probabilistic state simulation stack addresses the covariate shift problem. For example, the probabilistic state simulation stack may be trained using a ground truth representation of human driving data, and at least a portion of the trained probabilistic state simulation stack may be deployed as an end-to-end drive stack in an autonomous or semi-autonomous machine (or some other type of control stack for other applications). This approach may be used to develop a robust driving policy that improves upon the current state of the art by sampling from predicted state distributions to generate (e.g., simulate) any number of new (e.g., driving) situations and traffic scenarios and training the policy to handle these previously unseen scenarios, thereby improving the accuracy and performance of policy.

In some embodiments, the probabilistic state simulation stack includes a perception encoder that uses one or more neural networks implemented using a transformer architecture, a sensor perspective encoding, a planned navigation route, and/or detected ego-motion to extract a scene embedding representing one or more aspects of an observed scene, such as visual information, motion information, ego-state of an ego-machine, a planned navigation route, and/or other types of information. Additionally or alternatively to using the perception encoder in a probabilistic state simulation stack, the perception and scene encoding techniques described herein may be used to extract and use a scene embedding as an input for 3D perception or reconstruction tasks such as object detection and classification (e.g., identifying pedestrians, vehicles, traffic signs, obstacles, etc.), semantic segmentation (e.g., labeling one or more elements in the scene by class), depth map extraction, trajectory prediction, path planning, navigation control (e.g., by a control stack that predicts one or more actions for the ego-machine to take), and/or localization or mapping (e.g., generating a 3D representation of the environment or localizing a 3D position within the environment), to name a few example tasks.

In some embodiments, a generative DNN may be trained as part of a probabilistic state simulation stack to predict a state distribution that models a range of possible world states, and predicted state distributions (or world models) may be sampled generatively to generate recovery scenarios (e.g., ground truth recovery scenarios) for other navigation policies or other supervised DNNs (e.g., a neural planner) that were not part of the probabilistic state simulation stack and that may run in a modular control stack. For example, an initial trajectory that drifts from an optimal or target trajectory may be generated in various ways, such as using a neural planner to control navigation of an ego-machine in a simulation environment or in a latent space of the generative DNN, or using a control stack trained as part of a probabilistic state simulation stack to generate control actions, perturbing the control actions, and using the perturbed control actions to control navigation of an ego-machine in a simulation environment. As such, the control stack trained as part of the probabilistic state simulation stack may be used to recover from the initial trajectory, and the resulting recovery trajectory may be recorded and used to train a navigation policy such as a neural planner (e.g., one that generated the initial trajectory).

As such, a probabilistic state simulation stack may be trained using sensor data to predict what happens next in the world, and the trained probabilistic state simulation stack may be used for various purposes, such as learning and validating a constituent end-to-end drive stack (e.g., comprising a perception encoder, generative DNN, and drive policy chain), generating simulated ground truth data to train some other DNN (e.g., training neural planners using recovery trajectories sampled from the state distribution predicted by a generative DNN state estimator, training other perception DNNs or navigation policy DNNs using ground truth traffic scenarios in perspective and/or top-down views generated by sampling from predicted state distributions), simulating future scenarios conditioned on ego-actions for planning, and/or otherwise. Co-training generative DNN state estimators with a perception encoder, navigation policy, and/or latent space decoder(s) facilitates training end-to-end control (e.g., drive) stacks without the use of hand-crafted code, improving the accuracy of the resulting trained models and the efficiency of the training process. As such, the present techniques may be used to increase the accuracy and performance of control stacks such as drive stacks; navigation policies such as neural planners; perception; and/or downstream tasks that rely on perception.

### BRIEF DESCRIPTION OF THE DRAWINGS

The present systems and methods for perception, scene encoding, probabilistic state simulation, and/or generation of recovery scenarios for autonomous machines and applications are described in detail below with reference to the attached drawing figures, wherein:

FIG. 1 illustrates an example technique in which a probabilistic state simulation stack may be used to solve covariate shift by training its navigation policy to drive towards states encountered in human expert demonstrations, in accordance with some embodiments of the present disclosure;

FIG. 2 illustrates an example probabilistic state simulation stack, in accordance with some embodiments of the present disclosure;

FIG. 3 illustrates an example perception encoder, in accordance with some embodiments of the present disclosure;

FIGS. 4A-4B illustrate some example reconstructed representations of an estimated state of a scene, in accordance with some embodiments of the present disclosure;

FIG. 5 illustrates an example technique for generating recovery trajectories, in accordance with some embodiments of the present disclosure;

FIG. 6A illustrates an example technique for initializing a probabilistic state simulation stack, in accordance with some embodiments of the present disclosure;

FIG. 6B illustrates an example technique for generating an initial trajectory using a neural planner to update a simulation environment, in accordance with some embodiments of the present disclosure;

FIG. 6C illustrates an example technique for generating an initial trajectory using a neural planner to update a simulation in the latent space of a probabilistic state simulation stack, in accordance with some embodiments of the present disclosure;

FIG. 7 is a flow diagram showing a method for generating a scene embedding representing an environment, in accordance with some embodiments of the present disclosure;

FIG. 8 is a flow diagram showing a method for operating at least a portion of a probabilistic state simulation stack as a control stack of an ego-machine, in accordance with some embodiments of the present disclosure;

FIG. 9 is a flow diagram showing a method for generating one or more recovery trajectories for one or more simulated ego-machines, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

Systems and methods are disclosed related to perception, scene encoding, probabilistic state simulation, and/or generation of recovery scenarios for autonomous machines and applications. The present techniques may be used for perception tasks, training end-to-end drive stacks, training neural planners, and/or otherwise, and may be used to control navigation of autonomous vehicles, semi-autonomous vehicles, robots, and/or other object or machine types.

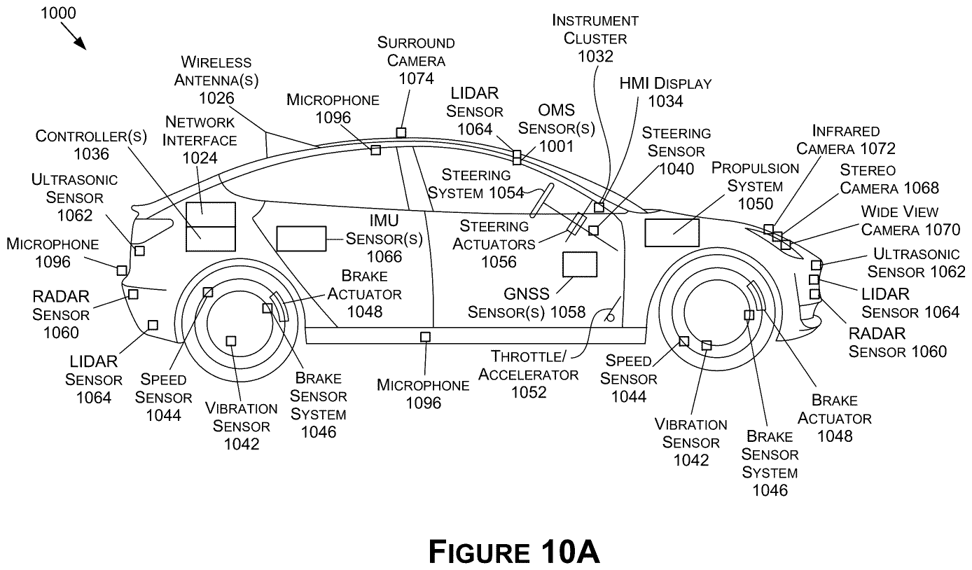

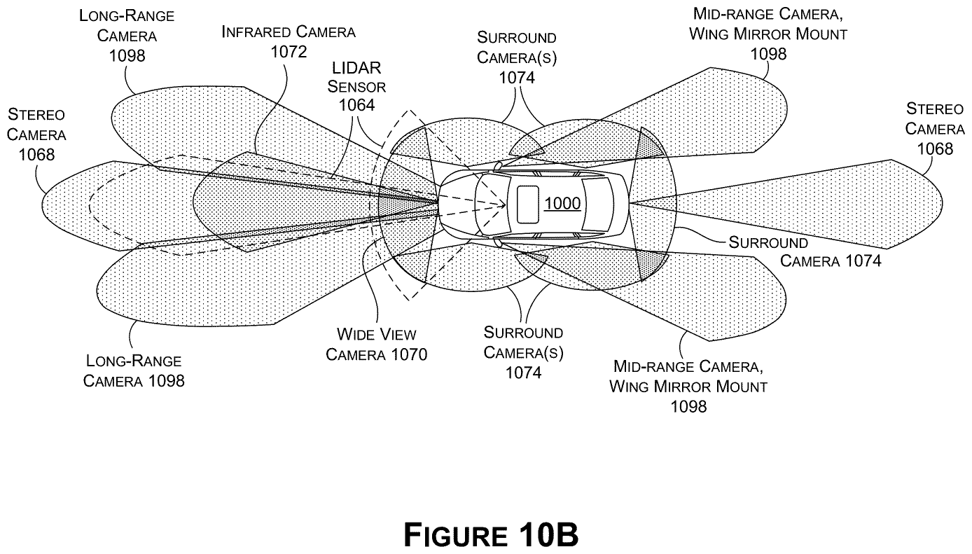

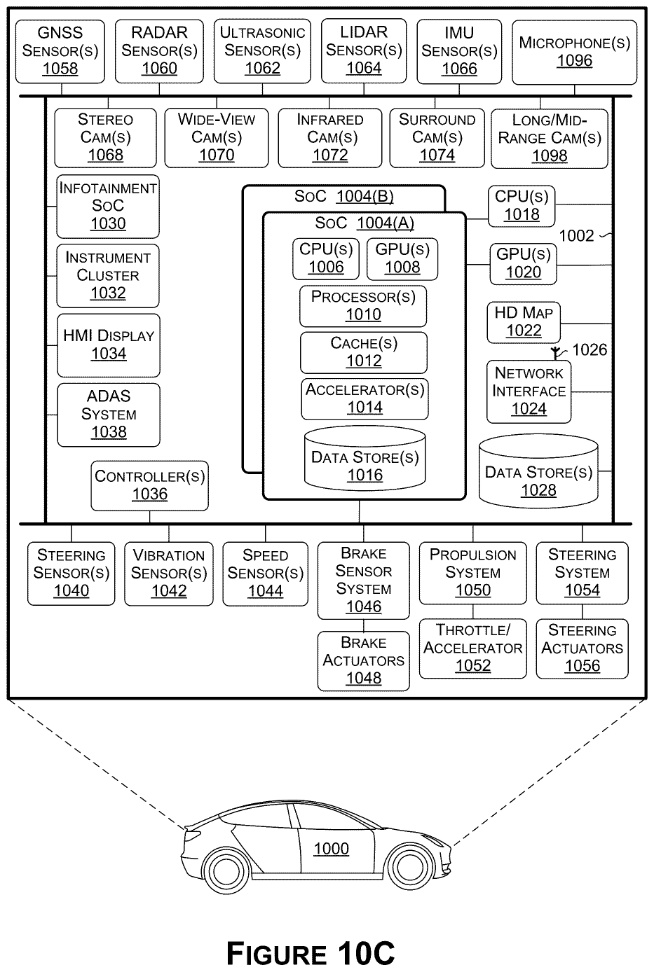

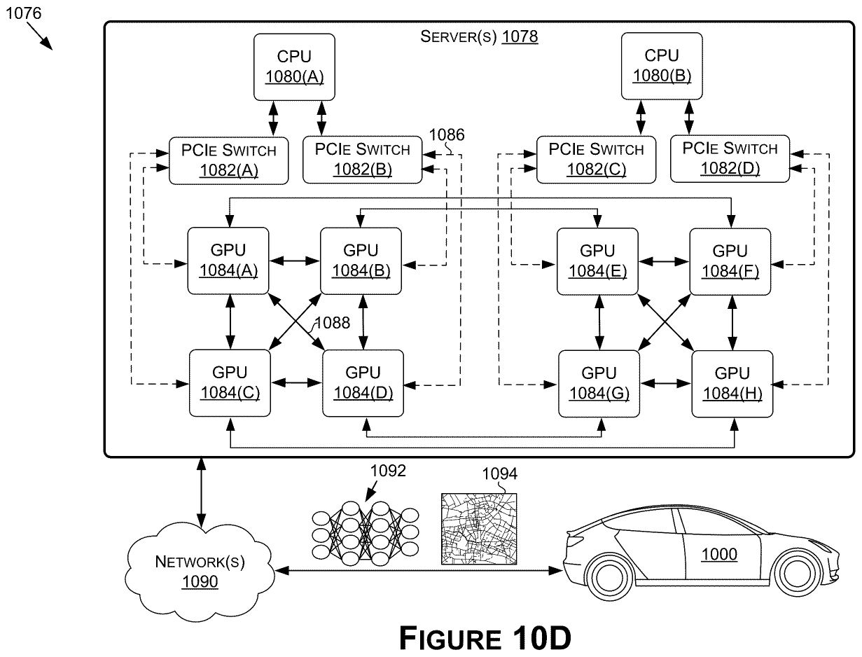

Although the present disclosure may be described with respect to an example autonomous or semi-autonomous vehicle or machine 1000 (alternatively referred to herein as “vehicle 1000” or “ego-machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to perception or navigation control for autonomous driving, this is not intended to be limiting, and the systems and methods described herein may be used in augmented reality, virtual reality, mixed reality, robotics, security and surveillance, autonomous or semi-autonomous machine applications, and/or any other technology spaces where perception or navigation control may be used.

In some embodiments, a probabilistic state simulation stack may be used to estimate and represent the state of an ego-machine (e.g., speed or position), traffic dynamics (e.g., the behavior of other road users), and/or static elements in the environment (e.g., roads, signs, or obstacles). The probabilistic state simulation stack may encode sensor data (e.g., camera images, LiDAR data, RADAR data) into a scene embedding, generate a posterior distribution representing an estimated current state of the scene by projecting the scene embedding and a representation of an aggregate history of the scene into a latent space using a first generative DNN, and generate a prior distribution representing an estimated future state of the scene by projecting the representation of the aggregate history of the scene into the latent space using a second generative DNN. As such, the estimated prior and posterior state distributions (which may be referred to as world models) may be probabilistically sampled and applied to: 1) a driving policy to predict a trajectory and/or control action (e.g., acceleration, breaking, steering) for the ego-machine to take, 2) one or more decoders to reconstruct one or more representations of the estimated state of the observed scene (e.g., simulated images, detected objects, semantic segmentations), and/or 3) a history aggregation network that generates the representation of the aggregate history for the subsequent iteration. During training, the predicted control action, divergence between the estimated prior and posterior state distributions, and/or reconstructed representation(s) of the estimated state of the observed scene may be used to generate corresponding losses, which may be used to update one or more components of the probabilistic state simulation stack. As such, the probabilistic state simulation stack may execute iteratively, recursively propagating the sampled state from a previous iteration and using it with detected sensor data representing a subsequent time slice during a subsequent iteration.

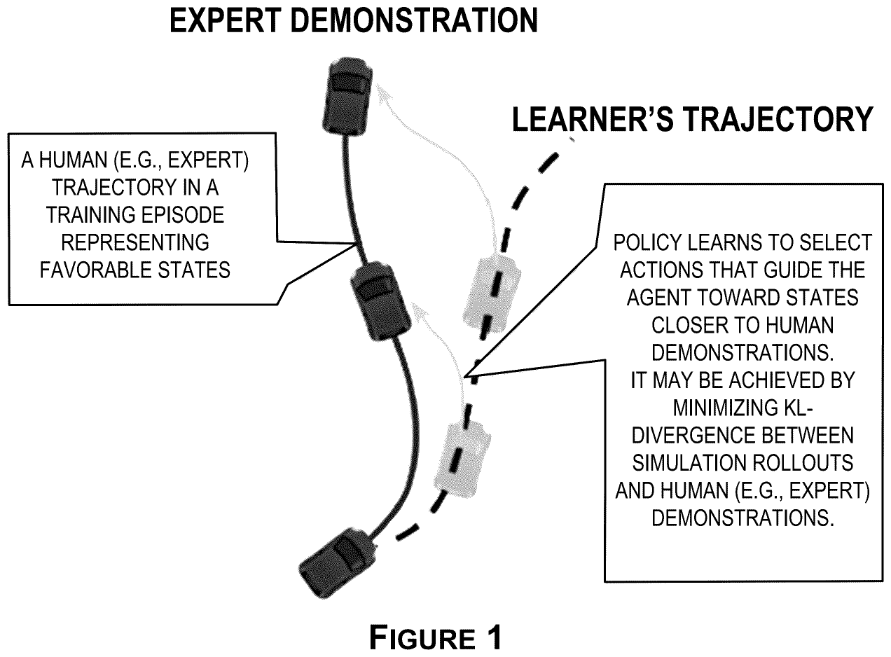

Co-training the driving (or other navigation) policy as part of probabilistic state simulation stack addresses the covariate shift problem. The second generative DNN effectively predicts a distribution of future world states (or world model), which facilitates sampling, from the learned latent space, new states representing scenarios that were not present in the training data. Executing the probabilistic state simulation stack as described above uses these sampled states to train the policy to recover from errors by picking actions corresponding to future latent states that are closer to states observed in human demonstrations, an example of which is illustrated in FIG. 1. As such, the trained probabilistic state simulation stack may be used to solve or mitigate the covariate shift problem in imitation learning. For example, the probabilistic state simulation stack may be trained using a ground truth representation of human driving data, and a chain of components from the probabilistic state simulation stack (e.g., the trained perception encoder that generates the scene embedding, first generative DNN that generates a posterior distribution representing an estimated current state of the scene, driving policy, and history aggregation network) may be used as an end-to-end drive stack in an autonomous or semi-autonomous machine (or some other type of control stack for other applications). This approach may be used to develop a robust driving policy that improves upon the current state of the art by sampling from predicted world models (state distributions) to generate (e.g., simulate) any number of new (e.g., driving) situations and traffic scenarios and training the policy to handle these previously unseen scenarios, thereby improving the accuracy and performance of policy.

In some embodiments, the probabilistic state simulation stack may include a perception encoder that uses one or more neural networks implemented using a transformer architecture, a sensor perspective encoding, a planned navigation route, and/or detected ego-motion to learn a representation the scene. For example, the perception encoder may encode a temporal sequence of frames of sensor data (e.g., two sequential frames of image data), and the encoded sequence of frames may be processed using a cross-attention layer between queries and keys-values—effectively looking back in (latent state) history using attention—to produce a set of motion feature tokens that represent the currently observed scene and that incorporate motion information. In some embodiments, the perception encoder may encode a representation of the perspective or direction of view of the corresponding sensor(s) (e.g., a sensor's intrinsic parameters and extrinsic parameters representing its pose relative to a reference coordinate system such as a rig coordinate system or a world space) or the perspective or direction of view represented by a subset of the sensor data generated by the sensor such as a pixel or patch of an image (e.g., the direction of a ray projected from the center of the sensor through a corresponding pixel or patch and the sensor's pose relative to a reference coordinate system such as a rig coordinate system or world space). As such, the perception encoder may combine the encoded representation of the sensor perspective with corresponding positional encodings for the encoded sensor data to map the encoded sensor data (e.g., tokens encoding corresponding patches of the sensor data) to a corresponding portion of the three-dimensional (3D) scene, thereby adding inductive priors for better 3D estimation and improving the resulting motion feature tokens generated by the cross-attention layer. The perception encoder may process the motion feature tokens using self-attention and a scene query that cross-attends with keys and values to output a scene embedding representing the observed scene. In some embodiments, a representation of a navigation route (e.g., a binary mask representing a top-down trajectory, a sequence of 2D waypoints, a sequence of navigation routing commands) and/or a representation of detected ego-motion (e.g., relative to a previous time slice) may be encoded and combined with the scene embedding to incorporate detected and/or planned ego-motion.

Generating a scene embedding using a transformer architecture, a sensor perspective encoding, a planned navigation route, and/or detected ego-motion provides a richer and more accurate representation of the scene than in prior techniques, and may be used to improve the accuracy of a downstream task. For example, in embodiments in which the perception encoder is implemented in a probabilistic state simulation stack or control stack that uses the scene embedding to predict a trajectory and/or control action (e.g., acceleration, breaking, steering) for the ego-machine to take, the improved scene embedding should also improve the accuracy of the trajectories and/or control actions generated by the navigation policy. In some embodiments, the perception and scene encoding techniques described herein may be used for 3D perception or reconstruction tasks such as object detection or classification, depth map extraction, semantic segmentation, and/or other tasks. As such, various embodiments may effective provide multi-view structure-from-motion functionality that encodes a 3D scene with corresponding semantics, 3D information, and/or motion information (e.g., velocities).

In some embodiments, a generative DNN trained as part of a probabilistic state simulation stack may be used to predict state distributions (or world models), which may be sampled generatively to generate recovery scenarios (e.g., ground truth or equivalent recovery scenarios) for other navigation policies or other supervised DNNs (e.g., a neural planner) that were not part of the probabilistic state simulation stack and that may run in a modular control stack. For example, the generative DNN that predicts a posterior distribution representing an estimated current state of the scene and the history aggregation network may be initialized with a real episode (e.g., recorded driving actions, a sequence of frames of sensor data) to aggregate the history of the scene, and a neural planner pre-trained using imitation learning may be run in a simulation environment to generate predicted trajectories or control actions based on the real episode, effectively letting the neural planner take over driving in a simulation. Additionally or alternatively to running the neural planner in a simulation environment, using the predicted trajectories or control actions to update the simulation, and using simulated sensor data to generate predicted trajectories or control actions for subsequent iterations, the simulation may effectively be run in a latent space by applying predicted control actions generated using the neural planner to the generative DNN that predicts a prior distribution representing an estimated future state of the scene, sampling a future state of the scene, and applying the sampled future scene state to one or more decoders corresponding to the input(s) of the neural planner to reconstruct the inputs for the next iteration. As such, the neural planner may be exposed to a scenario it was not trained to handle, such that the neural planner may drift away from an optimal trajectory due to covariate shift. Accordingly, after a simulated segment in which the neural planner controls navigation and drifts, the probabilistic state simulation stack may be executed with its trained navigation policy to roll out the remainder of the episode in latent space and generate a recovery trajectory. Additionally or alternatively to the neural planner controlling navigation to generate the scenarios for the navigation policy to recover from, one or more perturbations may be applied to predicted trajectories or control actions generated by the navigation policy of the probabilistic state simulation stack, and the navigation policy of the probabilistic state simulation stack may be used to roll out the remainder of the episode in latent space and generate a recovery trajectory. Accordingly, one or more recovery trajectories may be recorded and used to train the neural planner and counteract covariate shift.

As such, a probabilistic state simulation stack may be trained using sensor data to predict what happens next in the world, and the trained probabilistic state simulation stack may be used for various purposes, such as learning and validating a constituent end-to-end drive stack (e.g., comprising a perception encoder, generative DNN, and drive policy chain), generating simulated ground truth data to train some other DNN (e.g., training neural planners using recovery trajectories sampled from state distributions predicted by the probabilistic state simulation stack, training other perception DNNs or navigation policy DNNs using ground truth traffic scenarios in perspective and/or top-down views generated by sampling from predicted state distributions), simulating future scenarios conditioned on ego-actions for planning, and/or otherwise. Co-training generative DNN state estimators with a perception encoder, navigation policy, and/or latent space decoder(s) facilitates training end-to-end control (e.g., drive) stacks without the use of hand-crafted code, improving the accuracy of the resulting trained models and the efficiency of the training process. As such, the present techniques may be used to increase the accuracy and performance of control stacks such as drive stacks; navigation policies such as neural planners; perception; and/or downstream tasks that rely on perception.

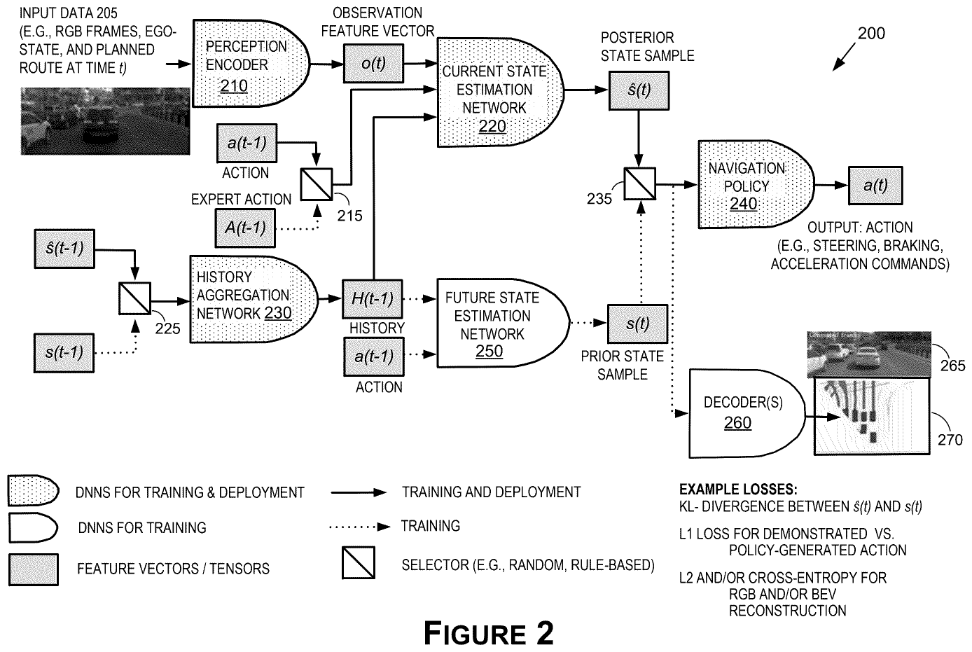

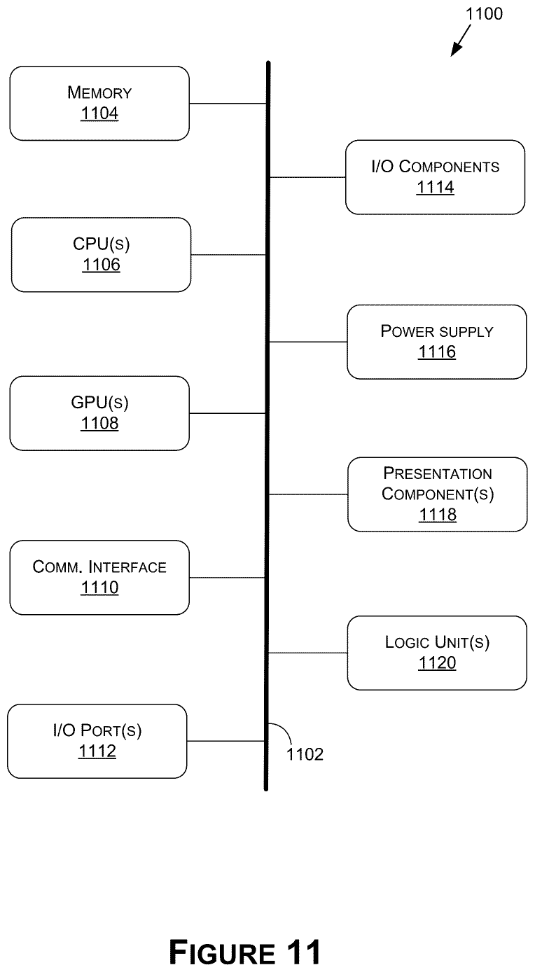

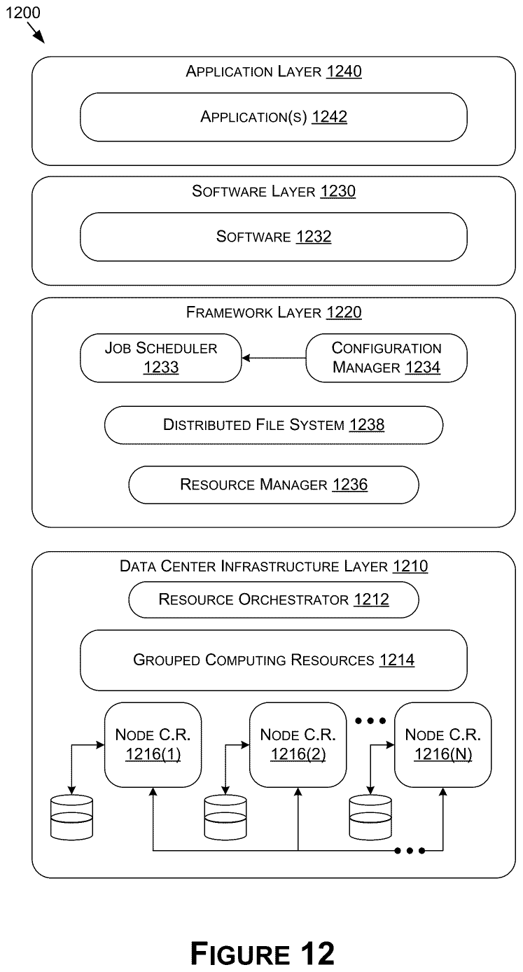

With reference to FIG. 2, FIG. 2 is an example probabilistic state simulation stack 200, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 1000 of FIGS. 10A-10D, example computing device 1100 of FIG. 11, and/or example data center 1200 of FIG. 12.

FIG. 2 illustrates some example configurations of a probabilistic state simulation stack 200, including one that may be used during training (illustrated with both solid and dotted arrows) and one that may be used during deployment as a control stack after training (illustrated with the solid arrows). The probabilistic state simulation stack 200 may include several deep neural networks (DNNs) which may be co-trained end-to-end, and the blocks illustrated with a stippling pattern in FIG. 2 may represent the trained DNNs, which may exchange information via tensors, may be optimized using back-propagated gradients, and may be deployed in an ego-machine (e.g., a vehicle) as an end-to-end control stack (e.g., drive stack).

In the embodiment illustrated in FIG. 2, the probabilistic state simulation stack 200 includes a perception encoder 210, a current state estimation network 220, a history aggregation network 230, a navigation policy 240, and a future state estimation network 250. In an example data flow, the probabilistic state simulation stack 200 (which may also be referred to as a probabilistic or stochastic generative world model) accepts input data 205 representing an observed or simulated environment. For example, the input data 205 may comprise some number of sequential frames of sensor data (e.g., two sequential RGB frames of image data generated by a front vehicle camera at 10 Hz), a representation of corresponding ego-states of the ego-machine during the time slice represented by each frame (e.g., ego-machine pose, speed, etc.), a planned navigation route, and/or other inputs. Depending on the scenario, the input data 205 may represent a previously recorded human driving session, simulated data, and/or a current driving session for real-time processing, to name a few examples. The input data 205 may be applied to the perception encoder 210, and the perception encoder 210 may extract a scene embedding at time t (illustrated as the observation feature vector o(t) in FIG. 2) from the input data 205. Taking an example training scenario using a previously recorded human (e.g., expert) driving session, the probabilistic state simulation stack 200 may apply the observation feature vector o(t), an encoded representation of the human driving action A at time t−1 (e.g., embedded using a DNN such as a multi-layer perceptron), and the previous state history H(t−1) to the current state estimation network 220 to compute the posterior latent state ŝ at time t. The current state estimation network 220 (e.g., a generative DNN) may compute a Gaussian distribution from which the posterior state ŝ(t) representing the estimated current state of the scene in the 3D environment (the world) may be sampled. Previous latent states (before time t) may be processed through a history aggregation network 230 (e.g., a gated recurrent unit (GRU) recurrent neural network (RNN)) to accumulate history H(t−1), and the history H(t−1) may be provided to the current state estimation network 220 and the future state estimation network 250.

The navigation policy 240 may use the prior history (e.g., as a direct input, or processed by an upstream component as illustrated in FIG. 2), a representation of a planned navigation route (e.g., as a direct input, or processed by an upstream component as illustrated in FIG. 2), and the sampled latent state at time t−1 to generate a representation of ego-actions a (e.g., steering, acceleration, breaking) for the ego-machine to take at time t. The future state estimation network 250 (e.g., a generative DNN) may accept the sampled latent state at time t−1, history at time t−1, and the control actions a computed by the navigation policy 240 to generate a prior estimate of the next predicted latent state at time t by computing a Gaussian distribution, from which a prior state s(t) representing the prior (estimated future) state of the scene in the 3D environment (the world) may be sampled. Latent state samples may be applied to one or more decoder(s) 260 to reconstruct a representation of the (e.g., observed) scene represented in the input data 205 (e.g., top-down segmentation mask(s), RGB perspective view images, etc.).

During training, the probabilistic state simulation stack 200 may be updated using one or more losses, such as using Evidence Lower bound (ELBO) loss to minimize the (e.g., Kullback-Leibler (KL)) divergence between the sampled prior latent state s (estimated future state) and the sampled posterior latent state ŝ (estimated observed state). In this example, the observed posterior latent state ŝ generated from sensor data and human (e.g., expert) actions effectively represents a desired state demonstrated by a human. Conversely, the prior latent state s derived from policy actions and world predictions effectively represents a potential new state that could be either beneficial or detrimental.

The (e.g., KL) divergence loss may be used to train the navigation policy 240 to select actions a that guide the world closer to the states observed in human demonstrations (posterior state). This approach allows the system to explore the planning space during training while being guided by human demonstrations. Consequently, the navigation policy 240 may learn to recover from mistakes or undesirable states and navigate towards favorable states observed in human demonstrations, as illustrated in FIG. 1.

The probabilistic state simulation stack 200 may include a selector 225 and/or a selector 235 that stochastically sample posterior and prior states from predicted Gaussian distributions, enabling further exploration. This process effectively trains the navigation policy 240 to mitigate covariate shift. As such, training may continue through some designated target goal (e.g., when all the DNNs converge), upon which the blocks illustrated with a stippling pattern in FIG. 2 may be deployed as an end-to-end control (e.g., drive) stack in an ego-machine. Additionally or alternatively, the future state estimation network 2350 may be used as a neural latent space simulator, facilitating the simulation of long-tail scenarios and/or the use of reinforcement learning to further enhance the navigation policy 240 or some other machine learning model (e.g., neural network).

Returning to the input data 205, the input data 205 may comprise or otherwise represent some number of sequential frames of sensor data generated using any number and/or any type of sensor, such as, without limitation, one or more cameras, LiDAR sensors, RADAR sensors, ultrasonic sensors, and/or other sensor types, such as those described below with respect to the autonomous vehicle 1000 of FIGS. 10A 10D. For example, the sensor(s) may include one or more sensors of an ego-machine, and the sensor(s) may be used to generate (e.g., a temporal sequence of) frames of sensor data (e.g., two sequential RGB frames of image data generated by a front vehicle camera at 10 Hz) that represent objects in the 3D environment around the ego-machine. Additionally or alternatively, the input data 205 may include a planned navigation route (e.g., generated using any known path-planning algorithm), a representation of an ego-state of the ego-machine for the time slice represented by each frame, such as ego-machine pose (e.g., detected using an inertial measurement unit (IMU) sensor(s) 1066, such as an accelerometer(s), gyroscope(s), magnetic compass(es), magnetometer(s), etc.), ego-machine speed (e.g., estimated using a speed sensor(s), a Global Positioning System (GPS), etc.), and/or other inputs. Depending on the application, the input data 205 may represent a previously recorded human driving session, simulated data, and/or a current driving session for real-time processing, to name a few examples. As such, the probabilistic state simulation stack 200 may collect, receive, and/or otherwise access a representation of the input data 205 and apply it to the perception encoder 210.

Depending on the embodiment, the perception encoder 210 (and the other components illustrated in FIG. 2) may be implemented using neural network(s) such as a convolutional neural network (CNN), but this is not intended to be limiting. For example, and without limitation, the object detection and/or tracking component 110 may include any type of a number of different networks or machine learning models, such as a machine learning model(s) using linear regression, logistic regression, decision trees, support vector machines (SVM), Naïve Bayes, k-nearest neighbor (Knn)), K means clustering, random forest, dimensionality reduction algorithms, gradient boosting algorithms, neural networks (e.g., auto encoders, convolutional, transformer, recurrent, perceptrons, Long/Short Term Memory (LSTM), large language model (LLM), vision language model (VLM), multi-modal language model, transformer, diffusion, encoder-only, decoder-only, encoder-decoder, Hopfield, Boltzmann, deep belief, de-convolutional, generative adversarial, liquid state machine, etc.), and/or other types of machine learning models.

In some examples, the machine learning model(s)/ neural network(s) may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s)/neural network(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model may be accessible via one or more APIs—such as REST APIs. As such, and in some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

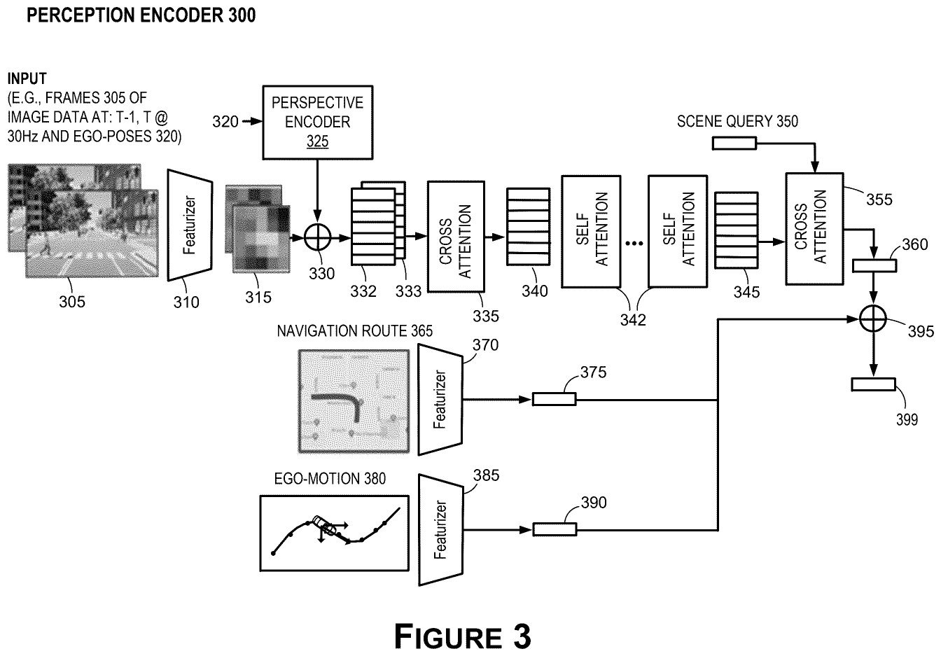

FIG. 3 illustrates an example perception encoder 300, in accordance with some embodiments of the present disclosure. For example, the perception encoder 300 represents a possible implementation of the perception encoder 210 of FIG. 2, however the perception encoder 300 may be implemented in other applications besides a probabilistic state simulation stack. Generally, the perception encoder 300 may accept any of the inputs and may be implemented using any of the architectures and techniques described above with respect to the perception encoder 210 of FIG. 2. As such, depending on the embodiment, some representation of sensor data (e.g., one or more images from one or more cameras, measured 3D data such a detected 3D point cloud, a projected 2D representation of detected 3D data, a temporal sequence of sensor data, etc.), a representation of corresponding detected or computed ego-state(s) such as corresponding detected or computed ego-pose(s) 320 (e.g., of the ego-machine) and/or current vehicle speed (not illustrated), a planned navigation route 365, and/or other types of input may be applied to the perception encoder 300, which may encode the input(s) into a scene embedding (e.g., scene embedding 360, scene embedding 399) of the (e.g., observed, simulated) scene represented in the input(s) (e.g., and that may correspond to the observation feature vector o(t) of FIG. 2). In some scenarios (e.g., during deployment), one or more sensors (e.g., such as those described below with respect to the autonomous vehicle 1000 of FIGS. 10A-10D) may be used to generate a set of input(s) (e.g., a sequence of frames) for each time slice (e.g., at a particular frame rate, such as 30 frames per second (fps)), and the set of input(s) for each time slice may be used by the perception encoder 300 to extract a scene embedding (e.g., which may be used to perform one or more downstream tasks), whether at the same frame rate as the sensor data is generated or some other frame rate.

In the example illustrated in FIG. 3, the perception encoder 300 accepts two sequential (e.g., perspective view) frames 305 (e.g., of RGB image data) representing times t and (t−1) (e.g., sampled at 10 Hz). Each of the frames 305 may be applied to a featurizer 310 (or feature extractor) to extract a corresponding embedding (e.g., and store the extracted embedding for use in subsequent iteration(s)). Generally, the featurizer 310 may be selected to correspond to the type of input it featurizes, and may be implemented using any type of the machine learning model or neural network, such as those described above. In an example implementation, the featurizer 310 comprises a (e.g., self-supervised) vision transformer backbone (e.g., Distillation with No Labels (DINO)v2) that extracts a set of image tokens 315 from corresponding frames 305. For example, the vision transformer backbone may divide each image into smaller (e.g., fixed-size) patches, flatten each patch into a vector representation, and linearly transform the vector for each patch into a corresponding token. The vision transformer backbone may combine these patch embeddings with positional encodings to preserve spatial information, and apply the resulting tokens to one or more transformer layers (e.g., self-attention and/or feed-forward networks) to learn rich, contextual features for each patch and output a representation of the extracted features for each image (e.g., a sequence of image tokens 315, one for each patch representing the learned features of the entire image).

In some embodiments, the extracted features (e.g., the image tokens 315) for each of the frames 305 may be applied to one or more transformer layers. Depending on the implementation, the extracted features may include different embeddings (e.g., tokens) corresponding to different regions (e.g., patches) of the input frames 305 (e.g., representative of an extracted feature map for each image). However, since the featurizer 310 may not encode a representation of the position of the patch represented by each token into the token itself, positional encodings may be combined with (e.g., added 330 to) corresponding embeddings (image tokens 315) to incorporate information about the relative position of each token (patch) within a corresponding frame (e.g., image) before applying the resulting embeddings to subsequent transformer layer(s).

Additionally or alternatively to combining the embedding (image token) for each of the patches with a positional encoding representing each patch's 2D position in a corresponding 2D frame, the embedding (image token) for each of the patches may be combined with (e.g., added 330 to) a perspective embedding that maps the corresponding frame (e.g., image) or the patch to a corresponding portion of the 3D scene. For example, the perception encoder 300 may include a perspective encoder 325 that generates an encoded representation of the perspective of the sensor(s) that generated the input frames of sensor data, and the perception encoder 300 may combine (e.g., add 330) the resulting sensor perspective encoding(s) with the corresponding frame embedding(s) (e.g., image tokens 315) extracted by the featurizer 310. Generally, the perspective or direction of view of a particular sensor may be represented in various ways, such as via the sensor's intrinsic parameters (e.g., represented as a vector, array, matrix, etc.), one or more components of the pose (e.g., the 3D location and/or orientation) of the sensor relative to a reference 3D coordinate system, such as a coordinate system defined relative to the ego-machine (e.g., a rig coordinate system with an origin corresponding to a reference point associated with the ego-machine such as its center of mass or the midpoint between rear axles) or a global 3D coordinate system (world space). For example, the perspective encoder 325 may generate a representation of the sensor's ego-pose relative to a world space by encoding and/or combining the sensor's (e.g., calibrated) extrinsic parameters (e.g., represented as a vector, array, matrix, etc.) defining the sensor's pose relative to a coordinate system of the ego-machine with a representation of a detected ego-pose 320 of the ego-machine relative to the world space (e.g., detected using an inertial measurement unit (IMU) sensor(s) 1066, such as an accelerometer(s), gyroscope(s), magnetic compass(es), magnetometer(s), etc.). As such, in some embodiments, the perspective encoder 325 may generate (e.g., using any suitable featurizer(s) implemented using any type of the machine learning model or neural network, such as those described above) an encoded representation of the sensor's intrinsic parameters and an encoded representation of the sensor's detected ego-pose, and may use any known technique (e.g., via addition 330, a neural network such as an MLP, etc.) to combine the resulting embeddings with the positional encodings (e.g., image tokens 315) for a corresponding frame of sensor data generated using that sensor. This is meant simply as an example, and other variations may be implemented within the scope of the present disclosure (e.g., combining intrinsic parameters, extrinsic parameters, and/or detected ego-pose 320 of the ego-machine prior to encoding, encoding separately prior to combining, encoding perspective relative to some other reference coordinate system, etc.).

Additionally or alternatively to computing and encoding a representation of the perspective of the center of a sensor, in some embodiments, the perspective encoder 325 may compute and encode the representation of the perspective represented by a subset of the sensor data generated by the sensor, such as a pixel or patch of an image. For example, the perspective encoder 325 may compute the perspective or direction of view of each individual pixel or patch encoded by a corresponding embedding (e.g., image token) extracted by the featurizer 310. Continuing with the example described above in which the featurizer 310 extracts image tokens 315 representing corresponding patches of each of the frames 305, the perspective encoder 325 may compute the perspective or direction of view of a representative (e.g., center) pixel from each patch in each of the frames 305.

For example, the perspective encoder 325 may generate a representation of the direction of a ray from the center of the sensor through an individual pixel in one of the frames 305 by transforming that pixel's coordinates to a 3D direction in the sensor coordinate system using the sensor's intrinsic parameters (e.g., and normalizing the resulting direction vector), and may generate a representation of one or more components of the sensor's pose (e.g., 3D location and/or orientation relative to a reference coordinate system such as a rig coordinate system or a world space, calibrated extrinsic parameters, detected ego-pose 320 of the ego-machine, etc.). As such, the perspective encoder 325 may generate (e.g., using any suitable featurizer(s) implemented using any type of the machine learning model or neural network, such as those described above) an encoded representation of the direction of the ray and/or the one or more components of the sensor's pose, and may use any known technique (e.g., via addition 330, a neural network such as an MLP, etc.) to combine the resulting embedding with the positional encoding (e.g., image token) for a corresponding portion of the frame (e.g., the image token for a corresponding patch the pixel came from).

As such, the image tokens 315 (each representing a patch) for each of the frames 305 may be combined (e.g., added 330) with corresponding positional encodings representing each patch's 2D position in a corresponding 2D frame of image data and/or corresponding perspective embeddings mapping each patch to a corresponding portion of the 3D scene (e.g., along a 3D ray originating from the center of the sensor and oriented toward the 3D scene), and may be applied to a series of transformer encoder layers that use cross-attention 335 and self-attention 342 to process the tokens, capturing relationships between different parts of the frames 305. For example, the perception encoder 300 may generate cross-attention queries 332 (Q) from the tokens of the most recent frame representing time t, may generate keys and values (K, V) 333 from the tokens of a prior frame, and cross-attention 335 may attend the queries 332 to the keys and values 333 to produce a set of motion feature tokens 340 that represent the currently observed scene and incorporate motion information. Embodiments that combine the image tokens 315 with corresponding perspective embeddings prior to cross-attention 335 effectively tell the perception encoder 300 which parts (e.g., pixels, patches) of different frames 305 represent the same part of the 3D environment, and the cross-attention 335 effectively performs a type of triangulation or multi-view geometrical processing, helping produce better motion features (e.g., a representation of how the content in the sequence of frames 305 has changed, represented by the motion feature tokens 340). Incorporating perspective embeddings is especially beneficial when processing real data. Taking automotive applications as an example, every vehicle typically has minor, but impactful differences in sensor mounting locations, lens characteristics, and calibrations, and incorporating perspective embeddings effectively accounts for differences in vehicle hardware from vehicle to vehicle.

Continuing with the example implementation illustrated in FIG. 3, the motion feature tokens 340 may be processed by one or more (e.g., four) blocks of self-attention 342 (e.g., with any number of heads, such as eight) to generate a contextualized embedding 345 that incorporates contextual information from the scene and/or motion sequence. As such, the contextualized embedding 345 may be used as keys and values, and a scene query token Q (represented by the scene query 350) may be used to cross-attend 355 with the keys and values (contextualized embedding 345) to output a (e.g., single vector representing) a scene embedding 360 (e.g., of dimension 512). In some embodiments, this scene embedding 360 may be provided to one or more downstream tasks.

Additionally or alternatively to using the scene embedding 360 for one or more downstream tasks, in some embodiments, the scene embedding 360 is combined (e.g., concatenated, added 395) with a representation of one or more other inputs, such as a planned navigation route 365, an ego-state of the ego-machine (e.g., a detected position, orientation, speed, ego-motion 380, etc.), and/or or otherwise. For example, the planned navigation route 365 may be generated using any known technique (e.g., any path-planning algorithm) and may be represented in a variety of ways (e.g., a rasterized binary mask visualizing a (e.g., top-down) view of a planned trajectory; a sequence of 2D waypoints; a list, array, queue, or other representation of a sequence of navigation routing commands (e.g., turn right in 100 feet, continue straight for 30 miles, take a left turn at the next stop light) which may be encoded using one-hot encoding, embedding vectors, RNN(s) to handle sequential processing, positional encodings and transformers, etc.) and a corresponding featurizer 370 (e.g., using any suitable featurizer(s) implemented using any type of the machine learning model or neural network, such as those described above) may be used to generate a corresponding embedding 375, which may be combined with (e.g., added 395 to, concatenated with dimensionality reduction) the scene embedding 360.

In some embodiments, one or more states of the ego-machine may be detected, provided to the perception encoder 300, featurized, and combined with the scene embedding 360. For example, ego-machine speed may be estimated (e.g., using a speed sensor(s), a Global Positioning System (GPS), etc.), encoded into a speed embedding, and combined with the scene embedding 360 (not illustrated). In some embodiments, a representation of the ego-motion 380 (e.g., speed, relative pose) of the ego-machine may be detected (e.g., estimated using a speed sensor(s) or GPS) or generated (e.g., by taking the difference between successive detected ego-poses 320), a corresponding featurizer 385 (e.g., using any suitable featurizer(s) implemented using any type of the machine learning model or neural network, such as those described above) may be used to generate a corresponding embedding 390, which may be combined with (e.g., added 395 to, concatenated with dimensionality reduction) the scene embedding 360. These are just a few examples, and other components of a detected ego-state (e.g., represented by GPU data, IMU data, and/or otherwise) may additionally or alternatively be featurized and combined with the scene embedding 360. As such, the resulting scene embedding 399 may be provided to one or more downstream tasks.

As such, the scene embedding 360 and/or the scene embedding may be used to represent one or more aspects of an observed scene, such as visual information, motion information, ego-state of an ego-machine, a planned navigation route, and/or other types of information.

The perception encoder 300 may be used to generate a scene embedding (e.g., that incorporates motion data) for various applications. For example, the scene embedding may be used as an input for 3D perception or reconstruction tasks such as object detection and classification (e.g., identifying pedestrians, vehicles, traffic signs, obstacles, etc.), semantic segmentation (e.g., labeling one or more elements in the scene by class), depth map extraction, trajectory prediction, path planning, navigation control (e.g., by a control stack that predicts one or more actions for the ego-machine to take), and/or localization or mapping (e.g., generating a 3D representation of the environment or localizing a 3D position within the environment), to name a few example tasks.

In some embodiments, implementing the featurizer 310 with a pre-trained vision transformer backbone facilitates training a robust perception encoder 300 on real data. As such, in some embodiments, the perception encoder 300 may be deployed in a simulator for validation of a downstream (e.g., driving or other navigation) task without the need for fine-tuning. Taking an embodiment that trains the perception encoder 300 as part of an end-to-end control stack (e.g., as in FIG. 2), if validation is successful, the trained end-to-end control (e.g., drive) stack may be directly deployed on the ego-machine (e.g., vehicle), in some embodiments in which it has been exclusively trained on real data.

Returning to the example probabilistic state simulation stack 200 illustrated in FIG. 2, the perception encoder 210 may extract an observation feature vector o(t) for each time slice, and the observation feature vector o(t) may be applied to the current state estimation network 220.

The current state estimation network 220 may comprise a generative DNN such as one or more stochastic neural networks (e.g., Bayesian neural network(s), variational autoencoders (VAEs)) that model the posterior state of the scene. More specifically, the current state estimation network 220 may model a latent state posterior distribution conditioned on observations represented by the observation feature vector o(t). For example, the current state estimation network 220 may estimate a surrogate distribution q(s^{(t)}|o(t), H(t−1), A(t−1)) as a Gaussian distribution (or conditioned on a(t−1) instead of A(t−1) during other scenarios such as deployment).

A(t−1) and a(t−1) represent navigation actions, and may include encoded representations of steering, acceleration, and/or braking states (e.g., concatenated and embedded into a 1D vector). A refers to previously recorded human (e.g., expert) actions, which may be input into the current state estimation network 220 (e.g., by a selector 215) during training. In some scenarios (e.g., during deployment of the blocks illustrated with a stippling pattern in a control stack), a refers to the actions generated by the navigation policy 240, which may be input into the current state estimation network 220 (e.g., by the selector 215). In some scenarios (e.g., when switching control from a human driver to the control stack), a representation of the most recent human actions may be input into the current state estimation network 220 as a(t−1) for some number of iterations before switching (via selector 215) to inputting the actions generated by the navigation policy 240 into the current state estimation network 220 as a(t−1). In some scenarios (e.g., when applying an action or trajectory predicted by a navigation policy such as the navigation policy 240 to a control algorithm such as model predictive control (MPC) that generates an optimized control action), a representation of the executed action as opposed to the action predicted by the navigation policy 240 may be input into the current state estimation network 220 as a(t−1).

The state history H(t−1) may effectively aggregate previous scene states deterministically using a hidden state of the history aggregation network 230, which may use any known technique to combine information from past states (e.g., a GRU RNN). As such, the history aggregation network 230 may effectively serve as a memory that is updated at each time slice based on a current input (e.g., ŝ(t−1) or s(t−1)) and the previous hidden state. The latent states ŝ(t−1) and s(t−1) represent the scene's evolution in a latent space from time t−1 to t. These states may be represented as 1D vectors (e.g., with dimensions 1×512).

As such, the current state estimation network 220 may estimate or approximate a true hidden state posterior probability distribution using an approximation distribution (e.g., a Gaussian distribution) learned by maximizing the Evidence Lower Bound (ELBO) using any known technique. Accordingly, the current state estimation network 220 may constitute a generative DNN that accepts the observation feature vector o(t) (e.g., scene embedding), past history H(t−1) up to time t−1, and embedded human (e.g., expert) actions A(t−1) (during training) at time step t−1, and computes parameters of a Gaussian distribution, which may be sampled to generate a posterior latent state sample ŝ(t). This state sample for time t may be recursively used as ŝ(t−1) for the next iteration of the probabilistic state simulation stack 200.

The future state estimation network 250 may comprise a generative DNN such as one or more stochastic neural networks (e.g., Bayesian neural network(s), variational autoencoders (VAEs)) that model the prior (estimated future) state of the scene. More specifically, the future state estimation network 250 may model stochastic latent space world transitions from s(t−1) to s(t) conditioned on ego-action a(t−1) and history H(t−1). As such, the future state estimation network 250 may accept as input a representation of the past history H(t−1) (e.g., which may incorporate past state samples s() up to and including time t−1) and the ego-action a(t−1) produced by the navigation policy 240 for time step t−1. In some embodiments, the future state estimation network 250 may additionally or alternatively accept a representation of a planned navigation route (e.g., embedding using a corresponding featurizer(s)) as input. Accordingly, the future state estimation network 250 may constitute a generative DNN that predicts a latent state as a Gaussian distribution, which may be sampled to generate a prior (estimated future) latent state sample s(t). Once trained, the future state estimation network 250 may be used to roll out new states without corresponding observations (in what may be considered an imagination mode) up to some horizon. These roll-outs may be used to re-simulate long-tail situations not seen in the training dataset.

Depending on the implementation, the navigation policy 240 may generate a representation of a control action a(t) and/or corresponding trajectory for the ego-machine to take based on the latent state at time t (e.g., ŝ(t) during deployment, ŝ(t) or s(t) during training as explained in more detail below). The navigation policy 240 may be implemented using any known technique, such those that use neural network(s) to predict or generate a planned trajectory or action (neural planners), classical control algorithms like MPC, some combination thereof (e.g., a neural planner that predicts an action followed by a classical control algorithm that optimizes the predicted action), and/or otherwise. In some embodiments, the navigation policy 240 may use a neural planner (e.g., implemented using a transformer architecture) that predicts a trajectory (e.g., instead of directly predicting acceleration and steering), and uses MPC during deployment to improve transfer from training to inference on the ego-machine (e.g., since MPC accounts for ego-machine dynamics and uses a predicted ego-trajectory as a reference to follow or guide its control actions). As such, the navigation policy 240 may effectively map the latent state of the scene to a desired navigation action (e.g., steering angles, acceleration or throttle, brake pressures, high-level navigation decisions such as changing lanes, etc.), and/or a trajectory that the ego-machine should follow. During training, the predicted action or trajectory may be compared to a corresponding ground truth human (e.g., expert) action and used to update the probabilistic state simulation stack 200. During deployment, the predicted action or trajectory may be provided to the ego-machine's control system(s) to control navigation of the ego-machine.

For example, the navigation policy 240 may include or be associated with a behavior planner, a behavior selector, a route planner, and/or a lane keeper. The behavior planner may be responsible for deciding the high-level actions that the ego-machine (e.g., vehicle) should take in response to the current and predicted state of the environment. Taking an ego-vehicle as an example, this may include decisions such as whether to change lanes, adjust speed, overtake another vehicle, or yield to pedestrians. These decisions may be made based on predefined rules or learned policies. As such, the behavior planner may embody the decision-making process that guides how the ego-machine should behave in various situations. In some embodiments, the behavior planner may generate potential behaviors or actions, and the behavior selector may choose the most appropriate one based on the current situation, objectives (such as safety, comfort, and efficiency), and possibly learned preferences. This selection process may effectively select an optimized action for the ego-machine to take. The route planner may generate a high-level path for the ego-machine to follow, usually over a longer distance (e.g., city blocks or miles). As such, the route planner may be responsible for navigation and ensuring that the ego-machine reaches its destination. The navigation policy 240 (e.g., embodied in the behavior planner and selector) may use this route (e.g., whether as a direct input, or processed by an upstream component as illustrated in FIG. 2) to make tactical decisions about how to follow the planned path in real-time. The lane planner may be responsible for more immediate, tactical decisions related to lane keeping, lane changes, and/or interactions with nearby traffic based on the path generated by the route planner. As such, the navigation policy 240 may determine when and how the ego-machine should change lanes or merge, which the lane planner may then execute.

During training (e.g., after pre-training the navigation policy 240 using imitation learning or behavior cloning), the probabilistic state simulation stack 200 may iterate or recurse over time using a selector 235 to choose either ŝ(t) or s(t) as input to the navigation policy 240 (and optionally one or more decoder(s) 260) for the current iteration with a designated probability, and/or using the same selection (or using a selector 225 to choose either ŝ(t) or s(t)) as input to the history aggregation network 230 for the next iteration with a designated probability. This probabilistic sampling of latent states during training mitigates covariate shift since s(t) is sampled stochastically and may include unusual long tail states to recover from.

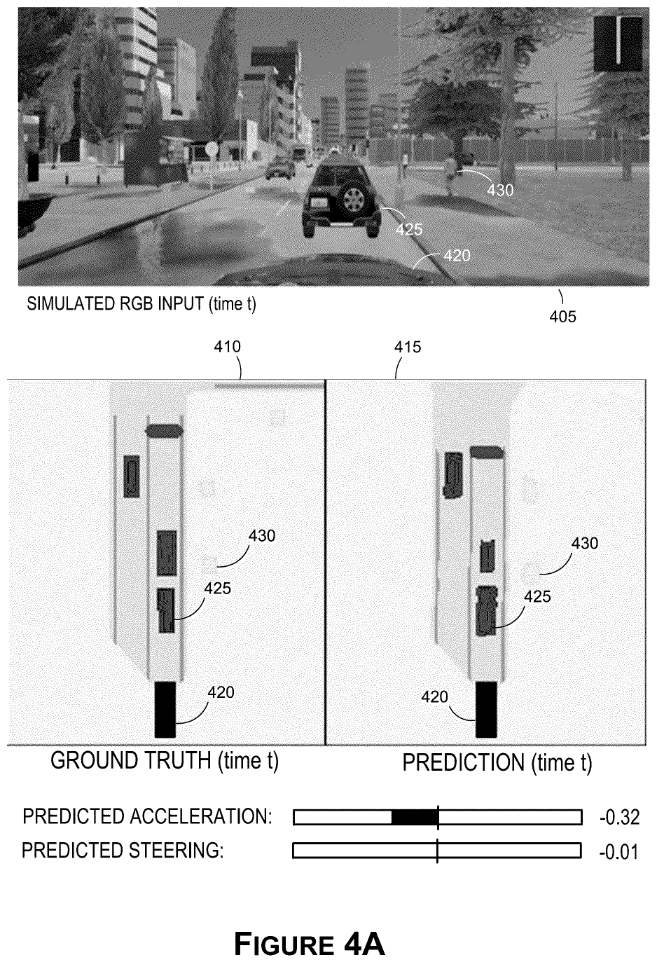

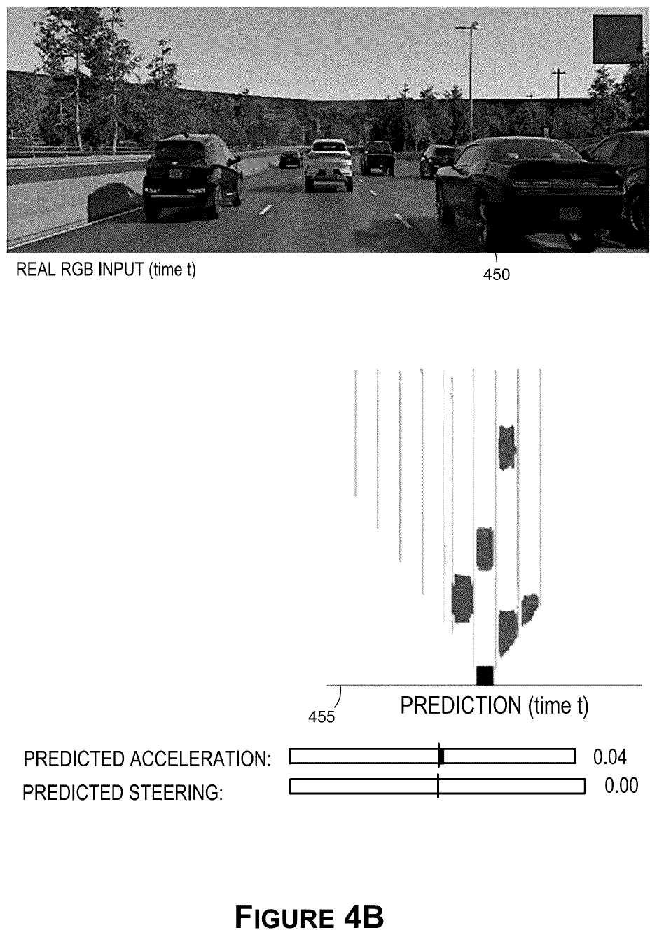

The sampled latent state may effectively encode a representation of a current (or future) scene, and may be used by the decoder(s) 260 to reconstruct a representation of the current (or future) scene. For example, the decoder(s) 260 may include one or more neural networks that decode latent state samples into RGB perspective view images (e.g., image 265), top-down (bird's-eye view) semantic segmentations (e.g., segmentation 270), a representation of bounding shapes for detected objects, a representation of lane locations, and/or otherwise. By iterating the probabilistic state simulation stack 200 over time, the decoder(s) 260 may be used to reconstruct videos or other temporal sequences of reconstructed data representing a (current or future) moving scene (e.g., with moving traffic, updating road lanes, object labels, etc.). The decoder(s) 260 may be implemented using generative network(s) such as generative adversarial networks (GANs) or latent diffusion models (e.g., Stable Diffusion). The decoder(s) 260 may be trained using reconstruction losses against corresponding input data 205 (e.g., sensor data such as RGB perspective view images) or ground truth targets (e.g., top-down segmentation masks). As such, the decoder(s) 260 may be used to decode a sequence of latent states into a temporally cohesive sequence of reconstructed data, such as an RGB perspective view video (e.g., which may be useful for system inspection and visualization). FIGS. 4A-4B illustrate some example reconstructed representations of an estimated state of a scene, in accordance with some embodiments of the present disclosure. For example, FIG. 4A illustrates a simulated RGB input image 405, a ground truth top-down segmentation mask 410 and a corresponding reconstructed top-down segmentation mask 415 (including representations of an ego-vehicle 420, other vehicles on the road such as vehicle 425, lane lines, and pedestrians such as pedestrian 430), and corresponding predicted acceleration and steering commands. FIG. 4B illustrates a real RGB input image 450, a corresponding reconstructed top-down segmentation mask 455 (including representations of other vehicles on the road and lane lines), and corresponding predicted acceleration and steering commands.

The probabilistic state simulation stack 200 (e.g., all DNNs in the probabilistic state simulation stack 200) may be trained using variational inference by maximizing ELBO loss, which may include log-likelihood of observations (e.g., RGB perspective view image(s), (e.g., top-down) semantic segmentation(s), predicted ego-action(s), etc.) and negative KL divergence between prior and posterior distributions estimated by the future state estimation network 250 and current state estimation network 220, respectively. Log-likelihood of observations may be used train the probabilistic state simulation stack 200 to learn a latent space that can be decoded (e.g., into real RGB images), and the future state estimation network 250 and current state estimation network 220 may learn to predict and estimate latent states minimizing their KL divergence. Note that the use of the decoder(s) 260 during training is optional, and the probabilistic state simulation stack 200 may be trained without the decoder(s) 260 using KL-divergence between ŝ(t) or s(t)) and (e.g., L1) loss between predicted and human-demonstrated actions to guide the training. Even without the use of reconstructed scene signals (e.g., detected lanes, pedestrians, traffic signs, etc.), the probabilistic state simulation stack 200 and its navigation policy 240 should still learn to control navigation well.

The training process may comprise different phases. For example, the perception encoder 210 and the decoder(s) 260 may be trained and/or may converge first, followed by the future state estimation network 250, and finally the navigation policy 240. To avoid over-fitting, a cyclic learning rate—a scheduling technique in which the learning rate oscillates between a minimum and a maximum value during training, rather than steadily decreasing or remaining constant—may be used. This approach allows the learning rate to periodically increase and decrease in cycles, helping the probabilistic state simulation stack 200 to escape local minima and saddle points, improving convergence and generalization.

As such, one or more components of the probabilistic state simulation stack 200 may be used in various ways. In one example illustrated by the solid lines in FIG. 2, the blocks illustrated with a stippling pattern in FIG. 2 (the perception encoder 210, the current state estimation network 220, the navigation policy 240, and the history aggregation network 230) may be deployed in an ego-machine (e.g., a vehicle) as an end-to-end control stack (e.g., drive stack). For example, this chain of components may run in real-time on a system-on-chip (which may correspond to the SoC(s) 1004 of FIG. 10C) of an ego-machine (e.g., an automotive SoC such as NVIDIA's DRIVE Orin™ SoC, which may serve as a central computer for in-vehicle computing). Other types of SoCs which may be used in robots or ego-machines include AI-optimized SoCs (e.g., NVIDIA Jetson Series), robotics SoCs (e.g., for robotics applications such as drones, service robots, or industrial robots), industrial SoCs (e.g., for industrial robots or automation systems for factory automation, robotics, or control systems), drone and unmanned aerial vehicle (UAV) SoCs (e.g., for handling flight control, navigation, and/or real-time video processing), and/or others. By training the control stack as part of the probabilistic state simulation stack 200 with the future state estimation network 250, the navigation policy 240 learns to handle scene states (e.g., new traffic scenarios) that were not represented in previous round(s) of imitation learning.

Additionally or alternatively to training a probabilistic state simulation stack with an end-to-end navigation control stack to control navigation of a real or simulated ego-object, a probabilistic state simulation stack may be trained with a manipulation control stack to control manipulation of one or more objects by a real or simulated ego-object (e.g., a robot arm, a digital character or avatar, etc.). Whereas in navigation control, a control stack may use inputs such as sensor data, ego-state of the ego-object, and/or a planned navigation route to perform path planning (e.g., predict a trajectory) and/or predict navigation controls (e.g., acceleration, steering, breaking), a manipulation control stack may use inputs such as sensor data, the ego-state of the (e.g., robot) manipulator (e.g., joint angles, end-effector position), object properties (e.g., size, weight, texture), and/or scene context (e.g., positions of other objects, obstacles) to perform grasp or manipulation planning (e.g., predict grasp location, grasp type, gripper orientation, arm trajectory) and/or predict manipulation controls (e.g., joint angles and velocities, end-effector position and orientation, force and torque to be applied). As such, one or more components of a trained probabilistic state simulation stack may be deployed as an end-to-end manipulation control stack and used to move objects conditioned on the overall scene represented in the inputs.

In some embodiments, one or more components of the probabilistic state simulation stack 200 may be used to train or test some other neural network, navigation policy, and/or control stack. For example, the other neural network, navigation policy, and/or control stack may be engaged in a training session using a training dataset, and the probabilistic state simulation stack 200 may be used to process an input representation of that training data and generate additional training data to augment the training dataset. For example, the probabilistic state simulation stack 200 may be run with the future state estimation network 250 (and/or the current state estimation network 220) to generate and sample a latent state, and the decoder(s) 260 may be used to decode the sampled latent state and reconstruct one or more representations of a future scene (or a current scene represented by the input data). Taking an example in which the other neural network, navigation policy, and/or control stack accepts one or more (e.g., perspective) images and detects objects, the decoder(s) 260 may be used to decode one more sampled latent state(s) into input training (perspective) image and ground truth bounding shapes, classifications, and/or other characteristics of detected objects. Taking an example in which the other neural network, navigation policy, and/or control stack accepts (e.g., top-down) semantic segmentation(s) and predicts a control action, the decoder(s) 260 may be used to decode one more sampled latent state(s) into semantic segmentation(s) used for input training data, and the navigation policy 240 may be used to predict control actions (and/or corresponding trajectories) used for ground truth training data. Generating sampled future states may effectively simulate scenarios that are difficult to observe (e.g., because they may be uncommon or dangerous), such as scenarios in which a driver swerves or crosses into an oncoming lane. As such, the probabilistic state simulation stack 200 may be used to generate unlimited data representing various traffic scenarios (e.g., represented in perspective and/or top-down views) for any traffic scenario, for any weather, time of day, and/or otherwise by sampling predicted latent states. This data may be used to augment existing training datasets and/or to train or test other perception DNNs, navigation policy DNNs, or control stacks via supervised learning.

In some embodiments, reconstructed (e.g., simulated) scenarios generated by the probabilistic state simulation stack 200 may be used for re-simulation. Instead of (or in addition to) replaying pre-recorded data from real-world driving scenarios in a simulation environment (e.g., NVIDIA's DriveSIM), reconstructed (e.g., simulated roll-out) scenarios generated by the probabilistic state simulation stack 200 may be input into the simulation environment and replayed to test and/or train a neural network, navigation policy, and/or control stack. Recreating and replaying scenarios generated by the probabilistic state simulation stack 200 allows the neural network, navigation policy, and/or control stack to interact with a potentially richer simulated environment in a feedback loop in re-simulation and enables more dynamic training and testing, particularly for simulated long-tail situations.

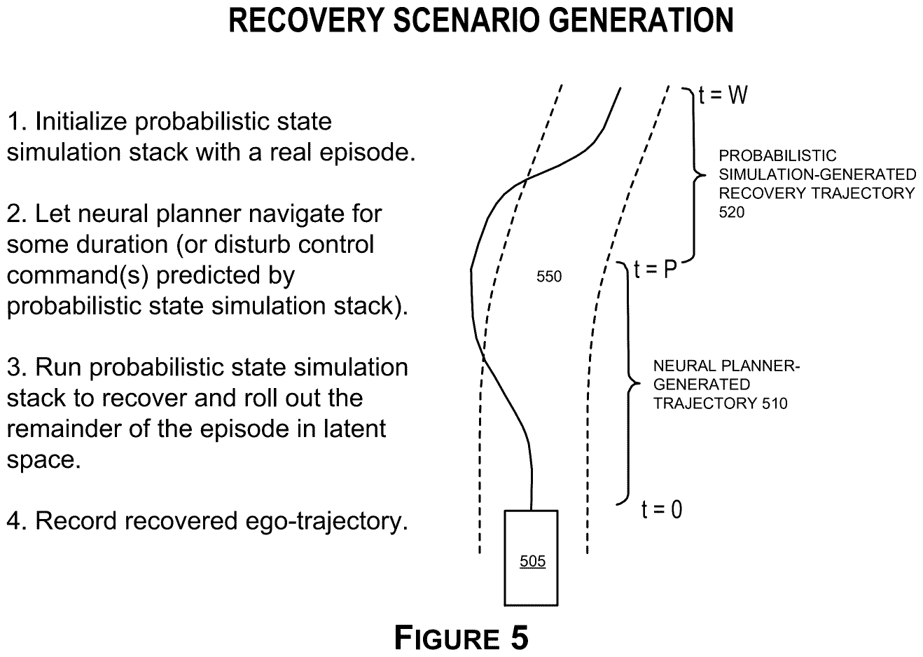

In some embodiments, a probabilistic state simulation stack (e.g., the probabilistic state simulation stack 200 of FIG. 2) may be used to generate recovery scenarios (e.g., recovery trajectories) for some other neural planner. FIG. 5 illustrates an example technique for generating recovery trajectories, in accordance with some embodiments of the present disclosure. In a high-level overview, a neural planner (e.g., pre-trained using imitation learning) may be used to control an ego-machine 505 in a simulation (e.g., generated using a simulation environment such as DriveSIM, generated in a latent space of a probabilistic state simulation stack)—or one or more control commands generated by the probabilistic state simulation stack may be perturbed—such that the ego-machine 505 begins to drift away from the center of the lane 550. As such, a representation of this simulated initial trajectory 510 may be applied to the probabilistic state simulation stack, and control of the ego-machine 505 in the simulation may be switched over to the navigation policy of the probabilistic state simulation stack. Accordingly, the ego-machine 505 should recover from the drifted trajectory, returning to the center of the lane 550, and a representation of this simulated recovery trajectory 520 (e.g., a reconstructed simulated roll-out scenario generated by the probabilistic state simulation stack) may be used to train the neural planner to avoid drifting out of the lane 550, thereby mitigating covariate shift.

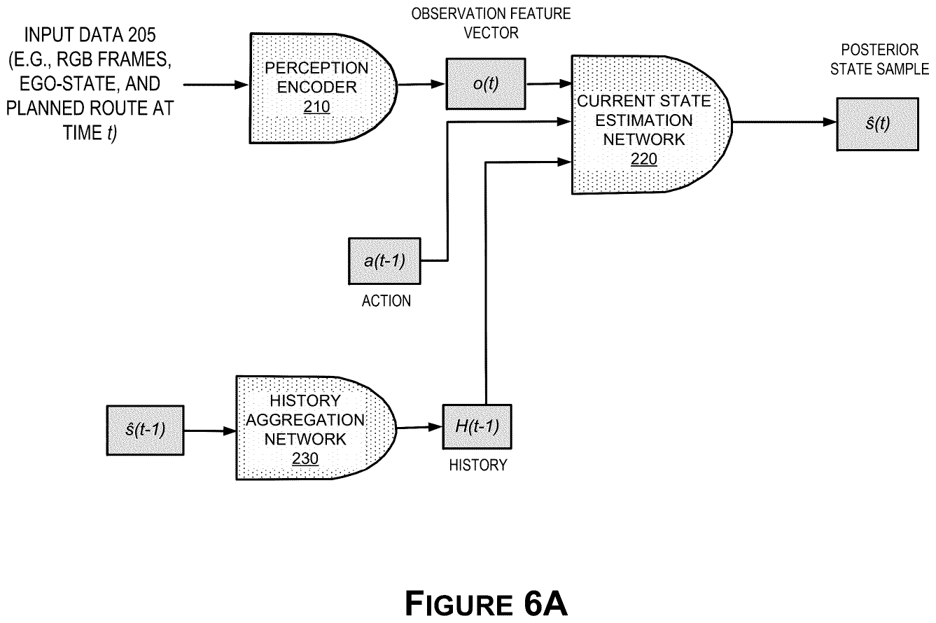

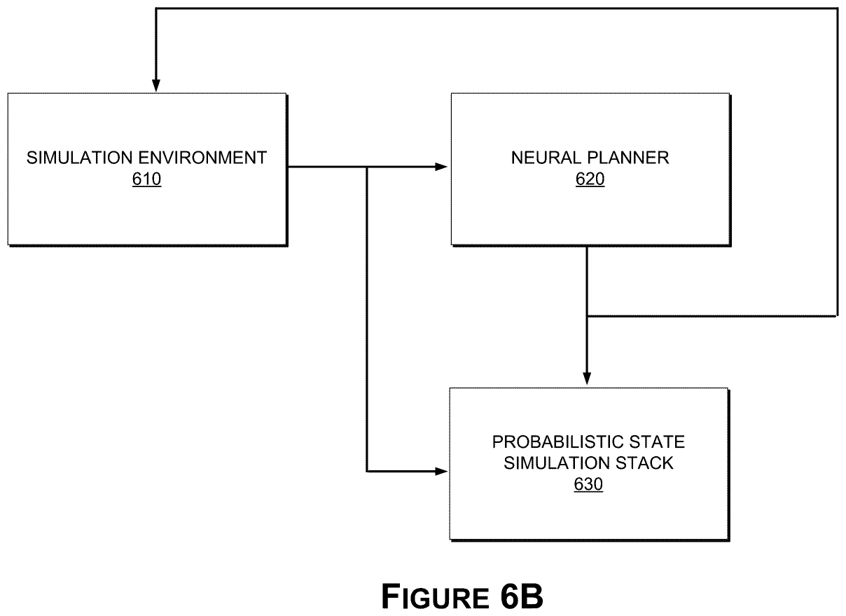

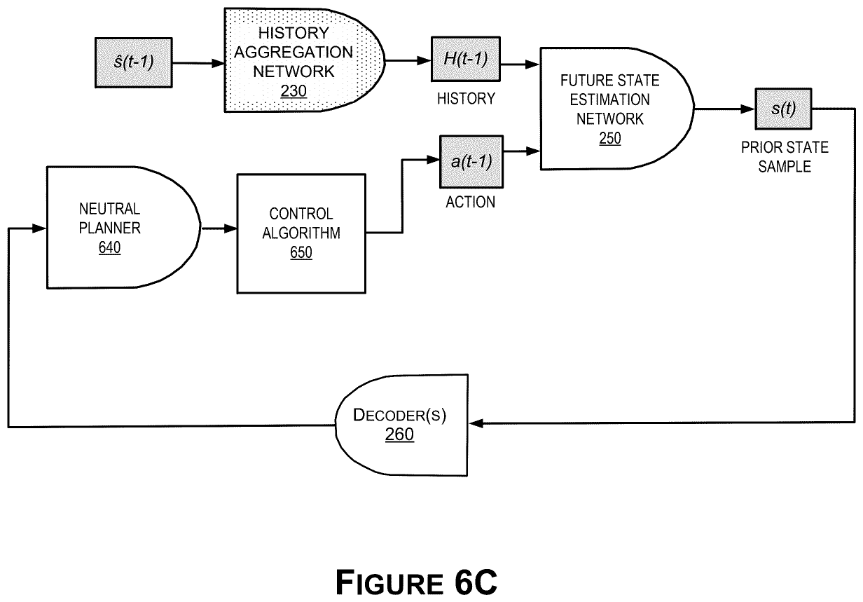

More specifically, a probabilistic state simulation stack (e.g., the trained probabilistic state simulation stack 200 of FIG. 2) may be initialized with a real episode to accumulate state. FIG. 6A illustrates an example technique for initializing a probabilistic state simulation stack, in accordance with some embodiments of the present disclosure. More specifically, FIG. 6A illustrates a configuration of the (e.g., trained) probabilistic state simulation stack 200 of FIG. 2 in which a representation of a real episode (e.g., a sequence of frames of sensor data, a recorded ego-machine state, a planned navigation route) is applied to the perception encoder 210, a representation of recorded driving action(s) (e.g., encoded acceleration, steering, and/or braking commands) is used as a(t−1) and applied to the current state estimation network 220, and this configuration iterates in a loop for some duration, number of input frames, number of time slices, etc. so the history aggregation network 230 can accumulate a representation of the latent state of the scene.

Returning to FIG. 5, in some embodiments (e.g., after initializing at least some of the components of the probabilistic state simulation stack), a representation of an initial trajectory (e.g., the trajectory 510) in which the ego-machine 505 diverges from an optimal or target trajectory may be generated and recorded. For example, a neural planner (e.g., pre-trained using imitation learning) may be used to control the ego-machine 505 in a simulation environment. FIG. 6B illustrates an example technique for generating an initial trajectory using a neural planner 620 to update a simulation environment 610. Generally, the simulation environment 610 (e.g., DriveSIM) may create a realistic virtual environment for testing and/or training neural networks such as those used in perception or autonomous driving systems. In an example automotive application, the simulation environment 610 may generate simulated driving scenarios, road conditions, and/or other aspects of various environments using simulated sensor models, vehicle dynamics, and/or interactions with traffic, pedestrians, or other dynamic or static objects or parts of the environment. Depending on what input(s) the neural planner 620 accepts, a corresponding representation of a simulated scene (e.g., recreating the last state of the real episode used to initialize the probabilistic state simulation stack) may be generated by the simulation environment 610 and/or input into the neural planner 620 to predict a control action and/or trajectory for the ego-machine 505 to take, the predicted control action and/or trajectory may be used to control the ego-machine 505 in the simulation environment 610 and update the simulation, and a representation of the updated scene in the simulation (e.g., simulated sensor data) may be applied to the neural planner 620 to predict subsequent actions for subsequent iterations. The process may be repeated for some duration, number of input frames, number of time slices, etc. to generate an initial trajectory (e.g., the trajectory 510). In some embodiments, the probabilistic state simulation stack 630 (e.g., which may correspond to the configuration of the probabilistic state simulation stack 200 illustrated in FIG. 6A) may accept a corresponding representation of the simulated scene generated by the simulation environment 610 as the input data 205, and the control action and/or trajectory predicted by the neural planner 620 (and/or a corresponding control algorithm) may be used as a(t−1) and applied to the current state estimation network 220 so the history aggregation network 230 can update the accumulated history to include the simulated scene.

Additionally or alternatively, in some embodiments, an initial trajectory for the ego-machine 505 may be generated by applying one or more perturbations (e.g., a small modification or disturbance) to a predicted control action (e.g., steering, acceleration, braking) or trajectory (e.g., a planned path) generated by a navigation policy and/or control stack of the probabilistic state simulation stack (e.g., the probabilistic state simulation stack 200 of FIG. 2). For example, a corresponding representation of a simulated scene (e.g., recreating, in the simulated environment, the last state of the real episode used to initialize the probabilistic state simulation stack) may be input into a control stack of the probabilistic state simulation stack to predict a control action and/or trajectory for the ego-machine 505 to take, and the predicted control action and/or trajectory may be disturbed. For example, if the navigation policy of the control stack predicts a steering angle of 5 degrees, a perturbation may add or subtract a small amount (e.g., 0.5 degrees), creating a slightly altered action. In another example, if a predicted trajectory suggests a smooth curve with a series of waypoints, perturbations may adjust these waypoints slightly off the intended path (e.g., to the left or right, or modifying the curvature). Perturbations may be random (e.g., adding noise), pre-defined modifications (e.g., consistently increasing or decreasing the steering angle by a fixed amount), and/or otherwise. As such, the modified control action and/or trajectory may be used to control the ego-machine 505 in the simulation and update the simulation, and a representation of the updated scene in the simulation (e.g., simulated sensor data) may be applied to the control stack of the probabilistic state simulation stack to predict (e.g., and perturb) subsequent actions for subsequent iterations. The process may be repeated for some duration, number of input frames, number of time slices, etc. to generate an initial trajectory (e.g., the trajectory 510).

Additionally or alternatively, in some embodiments, an initial trajectory for the ego-machine 505 may be generated using a neural planner (e.g., pre-trained using imitation learning) to control the ego-machine 505 in the latent space of a probabilistic state simulation stack (e.g., the probabilistic state simulation stack 200 of FIG. 2). FIG. 6C illustrates an example technique for generating an initial trajectory using a neural planner 640 to update a simulation in the latent space of a probabilistic state simulation stack, in accordance with some embodiments of the present disclosure. More specifically, FIG. 6C illustrates a configuration of the (e.g., trained) probabilistic state simulation stack 200 of FIG. 2 in which control actions predicted by the neural planner 640 and/or a corresponding control algorithm 650 (e.g., MPC) may be used as a(t−1) and applied as input to the future state estimation network 250 to predict (e.g., simulate) and sample a future latent state of the scene, which may be used by the decoder(s) 260 to reconstruct a corresponding input for the neural planner 640 during a subsequent iteration of the loop. During a first iteration, depending on what input(s) the neural planner 620 accepts, a corresponding representation of the last state of the real episode used to initialize the probabilistic state simulation stack may be applied to the neural planner 640 to predict a control action and/or trajectory for the ego-machine 505 to take (or a control algorithm 650 may predict the control action based on a trajectory predicted by the neural planner 640). The predicted control action may be used as a(t−1) and applied as input to the future state estimation network 250, which may effectively run a simulation in latent space by predicting and sampling a latent state that represents a future scene state in which the ego-machine 505 has executed the predicted control action or trajectory. As such, the decoder(s) 260 may be used to decode the sampled latent state and reconstruct one or more representations of the future scene that the neural planner 640 accepts. As such, the reconstruct representation(s) of the simulated updated scene sampled from latent space may be applied to the neural planner 640 to predict subsequent actions for subsequent iterations. In each iteration, the history aggregation network 230 may use the sampled state from the previous iteration (or from the initialization phase for the first iteration) to update the accumulated history of the scene for the future state estimation network 250. As such, the neural planner 640 may be exposed to a scenario it was not trained to handle, such that the neural planner may drift away from an optimal trajectory due to covariate shift. This configuration may iterate in a loop for some duration, number of input frames, number of time slices, etc. to generate an initial trajectory (e.g., the trajectory 510).

As such, and returning to FIG. 5, regardless of the technique used to generate the initial trajectory (e.g., 510) that diverges from an optimal or target trajectory, a probabilistic state simulation stack may be used to recover back towards the optimal or target trajectory (e.g., returning to the center of the lane 550). For example, the blocks illustrated with a stippling pattern in FIG. 2 (the perception encoder 210, the current state estimation network 220, the navigation policy 240, and the history aggregation network 230) may be run in a simulation environment to generate and record a representation of a recovery trajectory. In some embodiments, a representation of the last state of the scene in which the initial trajectory was generated may be applied to the perception encoder 210, a representation of the last recorded driving action(s) (e.g., encoded acceleration, steering, and/or braking commands) from the initial trajectory may be used as a(t−1) and applied to the current state estimation network 220, and the accumulated history of the scene (e.g., initialized in the configuration illustrated in FIG. 6A, updated to include a representation of the scene in which the initial trajectory was generated) may be used as H(t−1) and applied to the current state estimation network 220. As such, the navigation policy 240 may predict a control action (or a trajectory, and a corresponding control algorithm may optimize the control action), the predicted control action and/or trajectory may be used to control the ego-machine 505 in the simulation environment and update the simulation, and a representation of the updated scene in the simulation (e.g., simulated sensor data) may be applied to the perception encoder 210 for the control stack of the probabilistic state simulation stack 200 to predict subsequent actions for subsequent iterations. This configuration may iterate for some duration, number of input frames, number of time slices, etc. to generate the recovery trajectory 520. As such, a representation of the recovery trajectory 520, the corresponding control actions, and/or the simulated environment in which the recovery trajectory 520 was generated may be recorded and used as a training episode to train a neural network, navigation policy, and/or control stack, such as a neural planner that generated the initial trajectory (e.g., using imitation learning).

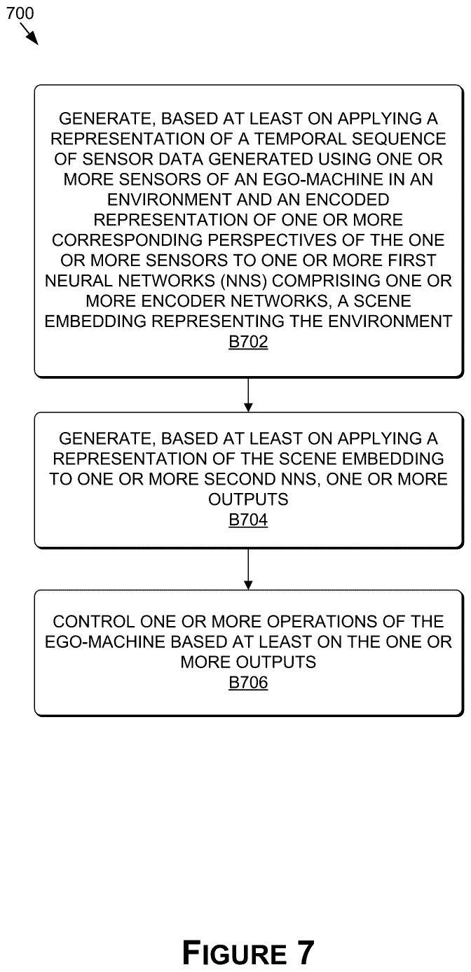

Now referring to FIGS. 7-9, each block of methods 700, 800, and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a standalone service, a hosted service (standalone or in combination with another hosted service), or a plug-in to another product, to name a few. In addition, the methods may be described, by way of example, with respect to the probabilistic state simulation stack 200 of FIG. 2 or the perception encoder 300 of FIG. 3. However, these methods may additionally or alternatively be executed by any one system, or any combination of systems, including, but not limited to, those described herein.

FIG. 7 is a flow diagram showing a method 700 for generating a scene embedding representing an environment, in accordance with some embodiments of the present disclosure. The method 700, at block B702, includes generating, based at least on applying a representation of a temporal sequence of sensor data generated using one or more sensors of an ego-machine in an environment and an encoded representation of one or more corresponding perspectives of the one or more sensors to one or more first neural networks (NNs) comprising one or more encoder networks, a scene embedding representing the environment. Taking an example encoder network such as the perception encoder 300 of FIG. 3, the frames 305 (e.g., of RGB image data) may be applied to the featurizer 310 (or feature extractor) to extract a corresponding embedding (e.g., a set of image tokens 315 for each of the frames 315), and the perspective encoder 325 may generate an encoded representation of the perspective of the sensor(s) that generated the input frames of sensor data. As such, the perception encoder 300 may combine (e.g., add 330) the resulting sensor perspective encoding(s) with the corresponding frame embedding(s) (e.g., image tokens 315) extracted by the featurizer 310 and apply the resulting embeddings to subsequent transformer layer(s) (e.g., cross-attention 335, self-attention 342, cross-attention 355) to generate a scene embedding (e.g., the scene embedding 360 or the scene embedding 399).

The method 700, at block B704, includes generating, based at least on applying a representation of the scene embedding to one or more second NNs, one or more outputs. For example, with respect to FIG. 2, the perception encoder 210, the current state estimation network 220, the navigation policy 240, and the history aggregation network 230 may be deployed in an ego-machine (e.g., a vehicle) as an end-to-end control stack (e.g., drive stack). As such, an observation feature vector o(t) extracted by the perception encoder 210 may be applied to the current state estimation network 220 to generate and sample a posterior state ŝ(t), and the navigation policy 240 may use the prior history (e.g., as a direct input, or processed by an upstream component as illustrated in FIG. 2), a representation of a planned navigation route (e.g., as a direct input, or processed by an upstream component as illustrated in FIG. 2), and the sampled latent state at time t−1 to generate a representation of ego-actions a (e.g., steering, acceleration, breaking) for the ego-machine to take at time t. More generally, the scene embedding may be used as an input for 3D perception or reconstruction tasks such as object detection and classification (e.g., identifying pedestrians, vehicles, traffic signs, obstacles, etc.), semantic segmentation (e.g., labeling one or more elements in the scene by class), depth map extraction, trajectory prediction, path planning, navigation control (e.g., by a control stack that predicts one or more actions for the ego-machine to take), and/or localization or mapping (e.g., generating a 3D representation of the environment or localizing a 3D position within the environment), to name a few example tasks.

The method 700, at block B706, includes controlling one or more operations of the ego-machine based at least on the one or more outputs. The output(s) of the one or more second NNs will typically depend on the applicable task and/or the implementation, and may be provided to corresponding control component(s) of the ego-machine. Generally, the applicable control component(s) may depend on the task and/or the implementation. Taking automotive applications as an example, in some embodiments, the control component(s) are part of an ADAS such as the ADAS system 1038 of FIG. 10C, and the control component(s) may coordinate and/or manage one or more functions within the ADAS. Generally, the ADAS may use any known technique to assess the vehicle's surroundings, identify potential risks or hazards, and/or implement autonomous driving features such as adaptive cruise control, automatic emergency braking, lane-keeping assistance, and/or collision avoidance systems, to name a few examples. Taking an example implementation in which the output(s) represent one or more control actions a (e.g., steering, acceleration, breaking) for the ego-machine to take at time t, the control component(s) may trigger the ego-machine to take the predicted control action(s). Taking some other possible detection tasks as examples, if the output(s) indicate a predicted trajectory for the ego-machine to take, the control component(s) may convert the trajectory to corresponding control action(s) and trigger the ego-machine to take the control action(s). If the output(s) indicate one or more detected obstacles, the control component(s) may trigger the ego-machine to avoid the detected obstacles.

Taking driver monitoring system (DMS) tasks such as driver drowsiness or distraction detection as an example, if the output(s) indicate the driver is not attentive or in a drive-ready position, the control component(s) may trigger one or more alerts (auditory, visual, or haptic) to regain the driver's attention, adjust one or more driver assistance features such as adaptive cruise control (e.g., increase the following distance or reduce the vehicle's speed) or lane keeping assistance (e.g., be more proactive in correcting lane deviations), trigger the ADAS to execute one or more safety interventions (e.g., automatic braking, emergency steering, transition to autonomous driving mode), etc. Taking some example occupant monitoring system (OMS) tasks, if the output(s) indicate the presence of a detected occupant, the control component(s) may enable safety features such as airbags or seatbelt reminders, or activate systems such as climate control and/or infotainment. If the output(s) indicate a recognized gesture, the control component(s) may execute or trigger a corresponding function (e.g., adjusting volume, changing temperature, opening windows). The foregoing detection tasks and corresponding controls are meant simply as non-limiting examples, and variations and other detection tasks may be implemented within the scope of the present disclosure.

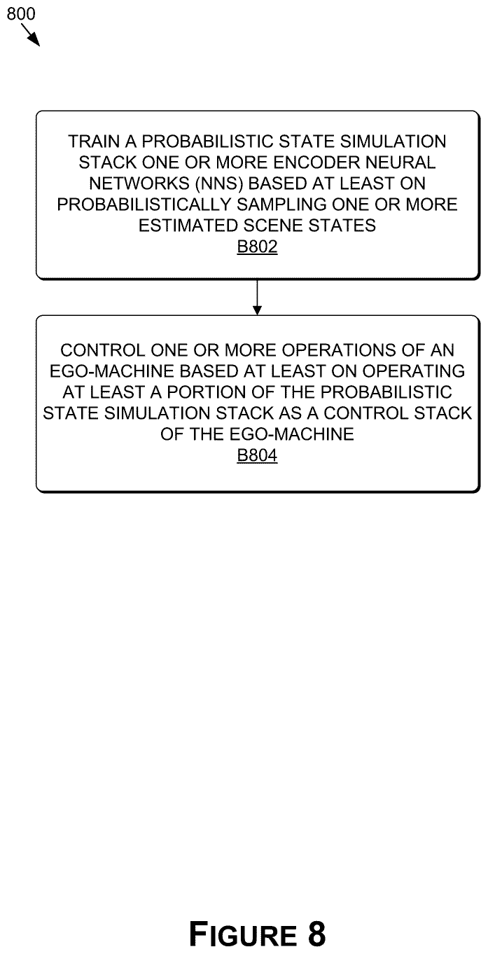

FIG. 8 is a flow diagram showing a method 800 for operating at least a portion of a probabilistic state simulation stack as a control stack of an ego-machine, in accordance with some embodiments of the present disclosure. The method 800, at block B802, includes training a probabilistic state simulation stack comprising one or more encoder neural networks (NNs) based at least on probabilistically sampling one or more estimated scene states. For example, with respect to the probabilistic state simulation stack 200 of FIG. 2, the probabilistic state simulation stack 200 may iterate or recurse over time using a selector 235 to choose either ŝ(t) or s(t) as input to the navigation policy 240 (and optionally one or more decoder(s) 260) for the current iteration with a designated probability, and/or using the same selection (or using a selector 225 to choose either ŝ(t) or s(t)) as input to the history aggregation network 230 for the next iteration with a designated probability. As such, with each iteration, the probabilistic state simulation stack 200 (e.g., all DNNs in the probabilistic state simulation stack 200) may be updated using variational inference by maximizing ELBO loss, which may include log-likelihood of observations (e.g., RGB perspective view image(s), (e.g., top-down) semantic segmentation(s), predicted ego-action(s), etc.) and negative KL divergence between prior and posterior distributions estimated by the future state estimation network 250 and current state estimation network 220, respectively. The probabilistic sampling of latent states during training mitigates covariate shift since s(t) is sampled stochastically and may include unusual long tail states to recover from.

The method 800, at block B804, includes controlling one or more operations of an ego-machine based at least on operating at least a portion of the probabilistic state simulation stack as a control stack of the ego-machine. For example, after training, the blocks illustrated with a stippling pattern in FIG. 2 (the perception encoder 210, the current state estimation network 220, the navigation policy 240, and the history aggregation network 230) may be deployed in an ego-machine (e.g., a vehicle) as an end-to-end control stack (e.g., drive stack). The operations of the ego-machine controlled using the control stack and corresponding control component(s) will typically depend on the applicable task and/or the implementation. Taking automotive applications as an example, in some embodiments, the control component(s) are part of an ADAS such as the ADAS system 1038 of FIG. 10C, and the control component(s) may coordinate and/or manage one or more functions within the ADAS. For example, the control stack may generate one or more predicted control actions (e.g., steering, acceleration, breaking) and/or trajectories for the ego-machine to take at time t, and the control component(s) may trigger the ego-machine to take the predicted control action(s) (and/or corresponding trajectories).

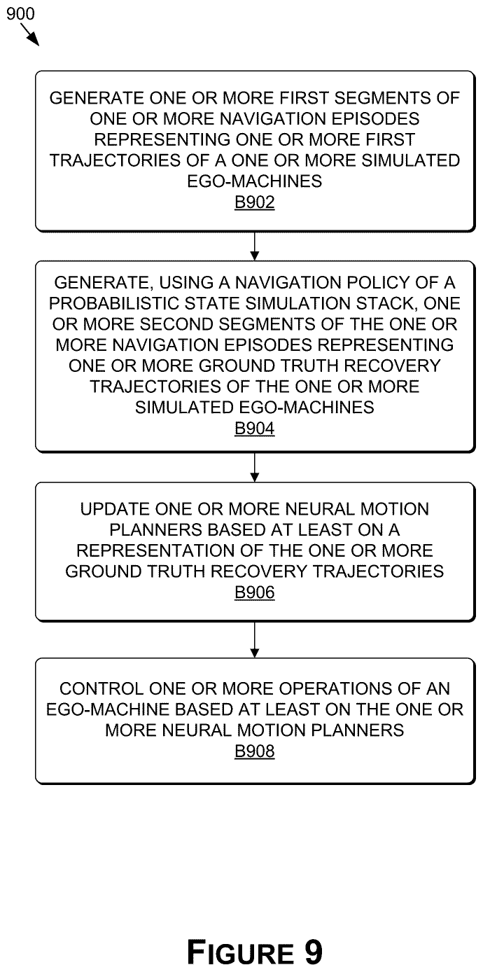

FIG. 9 is a flow diagram showing a method 900 for generating one or more ground truth recovery trajectories for one or more simulated ego-machines, in accordance with some embodiments of the present disclosure. The method 900, at block B902, includes generating one or more first segments of one or more navigation episodes representing one or more first trajectories of one or more simulated ego-machines. For example, with respect to FIG. 6B, the neural planner 620 (e.g., pre-trained using imitation learning) may be used to control an ego-machine and generate an initial trajectory in the simulation environment 610 (e.g., the neural planner-generated trajectory 510 illustrated in FIG. 5). Additionally or alternatively, in some embodiments, an initial trajectory for the ego-machine 505 may be generated by applying one or more perturbations (e.g., a small modification or disturbance) to a predicted control action (e.g., steering, acceleration, braking) or trajectory (e.g., a planned path) generated by a navigation policy and/or control stack of a probabilistic state simulation stack (e.g., the probabilistic state simulation stack 200 of FIG. 2). Additionally or alternatively, in some embodiments, an initial trajectory for the ego-machine 505 may be generated using a neural planner 640 to control the ego-machine 505 in the latent space of a probabilistic state simulation stack (e.g., the probabilistic state simulation stack 200 of FIG. 2), as illustrated in FIG. 6C.

The method 900, at block B904, includes generating, using a navigation policy of a probabilistic state simulation stack, one or more second segments of the one or more navigation episodes representing one or more ground truth recovery trajectories of the one or more simulated ego-machines. For example, the blocks illustrated with a stippling pattern in FIG. 2 (the perception encoder 210, the current state estimation network 220, the navigation policy 240, and the history aggregation network 230) may be run in a simulation environment to generate and record a representation of a recovery trajectory (e.g., the recovery trajectory 520 illustrated in FIG. 5).

The method 900, at block B902, includes updating one or more neural motion planners based at least on a representation of the one or more recovery trajectories. For example, a representation of the recovery trajectory 520, the corresponding control actions, and/or the simulated environment in which the recovery trajectory 520 was generated may be recorded and used as a training episode to train a neural network, navigation policy, and/or control stack, such as a neural planner that generated the initial trajectory (e.g., the neural planner 620 of FIG. 6B, the neural planner 640 of FIG. 6C, some other neural planner).

The method 900, at block B902, includes controlling one or more operations of an ego-machine based at least on the one or more neural motion planners. For example, the one or more neural motion planners may be deployed in an ego-machine (e.g., a vehicle) as part of (e.g., a navigation policy of) an end-to-end control stack (e.g., drive stack). Taking automotive applications as an example, in some embodiments, control stack may be implemented by an ADAS such as the ADAS system 1038 of FIG. 10C and used to control navigation of the ego-machine (e.g., the autonomous vehicle 1000 of FIGS. 10A-10D).

The systems and methods described herein may be used by—or may be used in combination with—without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), language model applications (e.g., large language models (LLMs), vision language models (VLMs), etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medical systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some embodiments, the systems and methods described herein may be performed within a simulation environment (e.g., NVIDIA's DriveSIM) using simulated data (e.g., simulated sensor data of simulated sensors of a simulated machine). For example, simulated (or virtual) sensor data (e.g., images of a simulated environment such as highway or warehouse environment generated from the perspective of one or more simulated sensors of a simulated ego-machine) may be applied to neural network comprising a perception encoder to perform one or more tasks (e.g., 3D perception or reconstruction, semantic segmentation, depth map extraction, trajectory prediction, path planning, navigation control, localization or mapping), and the neural network model's response may be used to control the simulated ego-machine within the simulated environment. These simulated operations may be used to test performance of the underlying algorithms, systems, and/or processes prior to deploying them in the real-world. In some instances, the simulation may be used to generate synthetic training data—e.g., images of a simulated environment generated from the perspective of one or more simulated sensors of a simulated ego-machine, and the synthetic training data (in addition or as an alternative to real-world data) may be used to train one or more neural networks such as a navigation policy or control stack implemented using one or more neural networks. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

### Example Autonomous Vehicle

FIG. 10A is an illustration of an example autonomous or semi-autonomous vehicle or machine 1000, in accordance with some embodiments of the present disclosure. The autonomous or semi-autonomous vehicle or machine 1000 (alternatively referred to herein as the “vehicle 1000,” “machine 1000,” “ego-vehicle 1000,” “ego-machine 1000,” “robot 1000,” etc.) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to allow the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to allow autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LiDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), one or more occupant monitoring system (OMS) sensor(s) 1001 (e.g., one or more interior cameras), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

Cameras with a field of view that include portions of the interior environment within the cabin of the vehicle 1000 (e.g., one or more OMS sensor(s) 1001) may be used as part of an occupant monitoring system (OMS) such as, but not limited to, a driver monitoring system (DMS). For example, OMS sensors (e.g., the OMS sensor(s) 1001) may be used (e.g., by the controller(s) 1036) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation allowing any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. Pat. No. 10,885,698, issued on Jan. 5, 2021. The real-time ray-tracing hardware accelerator may be used to quickly and efficiently determine the positions and extents of objects (e.g., within a simulation), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LiDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1016 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to allow communication with peripherals, audio codecs, power management, and/or other devices. The SoC(s) 1004 may be used to process data from cameras (e.g., connected over Gigabit Multimedia Serial Link and Ethernet), sensors (e.g., LiDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to allow wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated using the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LiDAR sensor(s) 1064. The LiDAR sensor(s) 1064 may be used for object and pedestrian detection, emergency braking, collision avoidance, and/or other functions. The LiDAR sensor(s) 1064 may be functional safety level ASIL B. In some examples, the vehicle 1000 may include multiple LiDAR sensors 1064 (e.g., two, four, six, etc.) that may use Ethernet (e.g., to provide data to a Gigabit Ethernet switch).

In some examples, the LiDAR sensor(s) 1064 may be capable of providing a list of objects and their distances for a 360-degree field of view. Commercially available LiDAR sensor(s) 1064 may have an advertised range of approximately 1000 m, with an accuracy of 2 cm-3 cm, and with support for a 1000 Mbps Ethernet connection, for example. In some examples, one or more non-protruding LiDAR sensors 1064 may be used. In such examples, the LiDAR sensor(s) 1064 may be implemented as a small device that may be embedded into the front, rear, sides, and/or corners of the vehicle 1000. The LiDAR sensor(s) 1064, in such examples, may provide up to a 120-degree horizontal and 35-degree vertical field-of-view, with a 200 m range even for low-reflectivity objects. Front-mounted LiDAR sensor(s) 1064 may be configured for a horizontal field of view between 45 degrees and 135 degrees. FIG. 10B illustrates example long-range and short-range horizontal fields-of-view for a LiDAR sensor 1064 with an example mounting location above the windshield, but other configurations such as those that include a grille-mounted LiDAR sensor 1064 (e.g., as illustrated in FIG. 10A) and/or a roof-mounted LiDAR scanner (e.g., for a data collection vehicle) are possible.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 1000. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may allow the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LiDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. As such, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(D) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Inference and Training Logic

One or more embodiments may be implemented using inference and/or training logic to perform inferencing and/or training operations. Details regarding inference and/or training logic are provided below.

In at least one embodiment, inference and/or training logic may include, without limitation, code and/or data storage to store forward and/or output weight and/or input/output data, and/or other parameters to configure. neurons or layers of a neural network trained and/or used for inferencing in aspects of one or more embodiments. In at least one embodiment, training logic may include, or be coupled to code and/or data storage to store graph code or other software to control timing and/or order, in which weight and/or other parameter information is to be loaded to configure., logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage may be included with other on-chip or off-chip data storage, including a processor's L1, L2, or L3 cache or system memory.

In at least one embodiment, any portion of code and/or data storage may be internal or external to one or more processors or other hardware logic devices or circuits. In at least one embodiment, code and/or data storage may be cache memory, dynamic randomly addressable memory (“DRAM”), static randomly addressable memory (“SRAM”), non-volatile memory (e.g., Flash memory), or other storage. In at least one embodiment, choice of whether code and/or data storage is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic may include, without limitation, a code and/or data storage to store backward and/or output weight and/or input/output data corresponding to neurons or layers of a neural network trained and/or used for inferencing in aspects of one or more embodiments. In at least one embodiment, code and/or data storage stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic may include, or be coupled to code and/or data storage to store graph code or other software to control timing and/or order, in which weight and/or other parameter information is to be loaded to configure., logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage may be included with other on-chip or off-chip data storage, including a processor's L1, L2, or L3 cache or system memory. In at least one embodiment, any portion of code and/or data storage may be internal or external to on one or more processors or other hardware logic devices or circuits. In at least one embodiment, code and/or data storage may be cache memory, DRAM, SRAM, non-volatile memory (e.g., Flash memory), or other storage. In at least one embodiment, choice of whether code and/or data storage is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage and code and/or data storage may be separate storage structures. In at least one embodiment, code and/or data storage and code and/or data storage may be same storage structure. In at least one embodiment, code and/or data storage and code and/or data storage may be partially same storage structure and partially separate storage structures. In at least one embodiment, any portion of code and/or data storage and code and/or data storage may be included with other on-chip or off-chip data storage, including a processor's L1, L2, or L3 cache or system memory.

In at least one embodiment, inference and/or training logic may include, without limitation, one or more arithmetic logic unit(s) (“ALU(s)”), including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage that are functions of input/output and/or weight parameter data stored in code and/or data storage and/or code and/or data storage. In at least one embodiment, activations stored in activation storage are generated according to linear algebraic and or matrix-based mathematics performed by ALU(s) in response to performing instructions or other code, wherein weight values stored in code and/or data storage and/or code and/or data storage are used as operands along with other values, such as bias values, gradient information, momentum values, or other parameters or hyperparameters, any or all of which may be stored in code and/or data storage or code and/or data storage or another storage on or off-chip.

In at least one embodiment, ALU(s) are included within one or more processors or other hardware logic devices or circuits, whereas in another embodiment, ALU(s) may be external to a processor or other hardware logic device or circuit that uses them (e.g., a co-processor). In at least one embodiment, ALU(s) may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage, code and/or data storage, and activation storage may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage may be cache memory, DRAM, SRAM, non-volatile memory (e.g., Flash memory), or other storage. In at least one embodiment, activation storage may be completely or partially within or external to one or more processors or other logical circuits. In at least one embodiment, choice of whether activation storage is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic may be used in conjunction with central processing unit (“CPU”) hardware, graphics processing unit (“GPU”) hardware or other hardware, such as field programmable gate arrays (“FPGAs”).

In at least one embodiment, inference and/or training logic may include, without limitation, hardware logic in which computational resources are dedicated or otherwise exclusively used in conjunction with weight values or other information corresponding to one or more layers of neurons within a neural network. In at least one embodiment, inference and/or training logic may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic may be used in conjunction with central processing unit (CPU) hardware, graphics processing unit (GPU) hardware or other hardware, such as field programmable gate arrays (FPGAs). In at least one embodiment, inference and/or training logic includes, without limitation, code and/or data storage and code and/or data storage, which may be used to store code (e.g., graph code), weight values and/or other information, including bias values, gradient information, momentum values, and/or other parameter or hyperparameter information. In at least one embodiment, each of code and/or data storage and code and/or data storage is associated with a dedicated computational resource, such as computational hardware and computational hardware. In at least one embodiment, each of computational hardware and computational hardware comprises one or more ALUs that perform mathematical functions, such as linear algebraic functions, only on information stored in code and/or data storage and code and/or data storage, respectively, result of which is stored in activation storage.

In at least one embodiment, each of code and/or data storage and corresponding computational hardware correspond to different layers of a neural network, such that resulting activation from one storage/computational pair of code and/or data storage and computational hardware is provided as an input to storage/computational pair of code and/or data storage and computational hardware, in order to mirror conceptual organization of a neural network. In at least one embodiment, each of storage/computational pairs may correspond to more than one neural network layer. In at least one embodiment, additional storage/computation pairs (not shown) subsequent to or in parallel with storage computation pairs may be included in inference and/or training logic.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R. s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may use distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in the appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in an illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably as far as system may embody one or more methods and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although the discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims. The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:
Clause 1. One or more processors comprising processing circuitry to obtain a scene embedding representing the environment based at least on applying a representation of a sequence of sensor data generated using one or more sensors of an ego-machine and an encoded representation of one or more corresponding perspectives of the one or more sensors to one or more first neural networks (NNs) comprising one or more encoder networks.
Clause 2. The one or more processors of clause 1, wherein the processing circuitry is further to generate one or more outputs based at least on applying a representation of the scene embedding to one or more second NNs.
Clause 3. The one or more processors of clause 1 or 2, wherein the processing circuitry is further to control one or more operations of the ego-machine based at least on the one or more outputs.
Clause 4. The one or more processors of clause 1, 2 or 3, wherein the processing circuitry is further to obtain the scene embedding based at least on processing the representation of the sequence of sensor data using cross-attention.
Clause 5. The one or more processors of clause 1, 2 or 3, wherein the processing circuitry is further to apply the encoded representation of the one or more corresponding perspectives of the one or more sensors to the one or more first NNs based at least on combining one or more encoded calibration parameters associated with the one or more sensors with one or more positional encodings.
Clause 6. The one or more processors of clause 1, 2 or 3, wherein the processing circuitry is further to apply the encoded representation of the one or more corresponding perspectives of the one or more sensors to the one or more first NNs based at least on combining one or more encoded directions of one or more light rays cast from the one or more sensors into the environment with one or more positional encodings.
Clause 7. The one or more processors of clause 1, 2 or 3, wherein the processing circuitry is further to apply the encoded representation of the one or more corresponding perspectives of the one or more sensors to the one or more first NNs based at least on combining a representation of one or more corresponding positions of the one or more sensors relative to a reference point associated with the ego-machine with one or more positional encodings.
Clause 8. The one or more processors of clause 1, 2 or 3, wherein the processing circuitry is further to obtain the scene embedding based at least on extracting one or more scene tokens using the one or more first NNs and combining the one or more scene tokens with a representation of one or more planned navigation routes of the ego-machine.
Clause 9. The one or more processors of clause 1, 2 or 3, wherein the processing circuitry is further to obtain the scene embedding based at least on extracting one or more scene tokens using the one or more first NNs and combining the one or more scene tokens with one or more top-down representations of one or more planned trajectories of the ego-machine.
Clause 10. The one or more processors of clause 1, 2 or 3, wherein the processing circuitry is further to generate the scene embedding based at least on extracting one or more scene tokens using the one or more first NNs and combining the one or more scene tokens with a representation of a planned sequence of two-dimensional waypoints of the ego-machine.
Clause 11. The one or more processors of clause 1, 2 or 3, wherein the processing circuitry is further to generate the scene embedding based at least on extracting one or more scene tokens using the one or more first NNs and combining the one or more scene tokens with a representation of a sequence of planned navigation routing commands associated with the ego-machine.
Clause 12. The one or more processors of clause 1, 2 or 3, wherein the processing circuitry is further to generate the scene embedding based at least on extracting one or more scene tokens using the one or more first NNs and combining the one or more scene tokens with a representation of detected ego-motion of the ego-machine.
Clause 13. The one or more processors of clause 1, 2 or 3, wherein the one or more first and second NNs represent at least a portion of a probabilistic state simulation stack comprising a navigation policy.
Clause 14. The one or more processors of clause 1, 2 or 3, wherein applying the representation of the scene embedding to the one or more second NNs triggers the one or more second NNs to perform at least one of one or more 3D perception tasks or one or more 3D reconstruction tasks based at least on the scene embedding extracted using one or more transformer NNs of the one or more encoder networks.
Clause 15. The one or more processors of clause 1, 2 or 3, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system using or deploying one or more inference microservices; a system that incorporates one or more machine learning models deployed in a service or microservice along with an OS-level virtualization package (e.g., a container); a system implemented at least partially in a data center; or a system implemented at least partially using cloud computing resources.
Clause 16. A method comprising extracting, based at least on applying a representation of a temporal sequence of sensor data generated using one or more sensors of an ego-machine in an environment to one or more neural networks (NNs) comprising one or more encoders, a scene embedding representing at least a portion of the environment.
Clause 17. The method of clause 16, further comprising controlling one or more operations of the ego-machine based at least on the scene embedding.
Clause 18. The method of clause 16 or 17, wherein extracting the scene embedding is further based at least on applying an encoded representation of one or more corresponding perspectives of the one or more sensors to one or more NNs.
Clause 19. The method of clause 16 or 17, wherein the scene embedding is obtained based at least on the one or more NNs processing the representation of the temporal sequence of sensor data using cross-attention.
Clause 20. The method of clause 16 or 17, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system using or deploying one or more inference microservices; a system that incorporates one or more machine learning models deployed in a service or microservice along with an OS-level virtualization package (e.g., a container); a system implemented at least partially in a data center; or a system implemented at least partially using cloud computing resources.
Clause 21. A system comprising one or more processors to control, within a simulation that is rendered using one or more light transport simulation algorithms, one or more operations of a simulated ego-machine based at least on a scene embedding representing a simulated environment in the simulation, the scene embedding obtained based at least on applying a representation of a sequence of simulated sensor data generated using one or more simulated sensors of the simulated ego-machine to one or more first neural networks (NNs) comprising one or more encoders.
Clause 22. The system of clause 21, wherein the simulation is generated, at least in part, using a three-dimensional (3D) content collaboration platform for 3D assets.
Clause 23. The system of clause 22, wherein the 3D content collaboration platform for 3D assets uses OpenUSD.
Clause 24. One or more processors comprising processing circuitry to update one or more neural networks (NNs) of a probabilistic state simulation stack based at least on probabilistically sampling one or more estimated scene states.
Clause 25. The one or more processors of clause 24, wherein the processing circuitry is further to control one or more operations of an ego-machine based at least on operating at least a portion of the probabilistic state simulation stack as a control stack of the ego-machine.
Clause 26. The one or more processors of clause 24 or 25, wherein the one or more NNs comprise one or more transformer neural networks, and the probabilistic state simulation stack comprises a navigation policy implemented using the one or more transformer neural networks.
Clause 27. The one or more processors of clause 24 or 25, wherein the processing circuitry is further to predict one or more ego-trajectories of the ego-machine using a navigation policy of at least the portion of the probabilistic state simulation stack.
Clause 28. The one or more processors of clause 24 or 25, wherein the processing circuitry is further to update the probabilistic state simulation stack based at least on decoding the one or more estimated scene states using latent diffusion.
Clause 29. The one or more processors of clause 24 or 25, wherein the processing circuitry is further to update the probabilistic state simulation stack based at least on updating one or more navigation policies of the probabilistic state simulation stack at least partially contemporaneously with one or more scene state estimation neural networks of the probabilistic state simulation stack.
Clause 30. The one or more processors of clause 24 or 25, wherein operating at least the portion of the probabilistic state simulation stack as the control stack comprises: extracting one or more visual features using a first transformer neural network (NN) of the one or more NNs and extracting one or more scene tokens based at least on a second transformer NN of the one or more NNs processing a representation of the one or more visual features.
Clause 31. The one or more processors of clause 24 or 25, wherein operating at least the portion of the probabilistic state simulation stack as the control stack comprises applying an encoded representation of one or more corresponding perspectives of one or more sensors of the ego-machine to one or more transformer NNs of the one or more NNs.
Clause 32. The one or more processors of clause 24 or 25, wherein the processing circuitry is further to update the probabilistic state simulation stack without decoding the one or more estimated scene states into one or more reconstructed representations.
Clause 33. The one or more processors of clause 24 or 25, wherein operating at least the portion of the probabilistic state simulation stack comprises at least one of: a perception task, a future scene state estimation task, or a generation of one or more control actions of the ego-machine.
Clause 34. The one or more processors of clause 24 or 25, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system using or deploying one or more inference microservices; a system that incorporates one or more machine learning models deployed in a service or microservice along with an OS-level virtualization package (e.g., a container); a system implemented at least partially in a data center; or a system implemented at least partially using cloud computing resources.
Clause 35. A method comprising controlling one or more operations of an ego-machine based at least on one or more predicted control actions generated using a control stack comprising at least a portion of a probabilistic state simulation stack comprising one or more neural networks (NNs).
Clause 36. The method of clause 35, further comprising updating the probabilistic state simulation stack based at least on decoding one or more estimated scene states using latent diffusion.
Clause 37. The method of clause 35, further comprising updating the probabilistic state simulation stack based at least on co-training one or more navigation policies of the probabilistic state simulation stack with one or more scene state estimation neural networks of the probabilistic state simulation stack.
Clause 38. The method of clause 35, further comprising operating at least the portion of the probabilistic state simulation stack as the control stack based at least on extracting one or more visual features using a first transformer NN of the one or more NNs and extracting one or more scene tokens based at least on a second transformer NN of the one or more NNs processing a representation of the one or more visual features.
Clause 39. The method of clause 35, further comprising operating at least the portion of the probabilistic state simulation stack as the control stack based at least on applying an encoded representation of one or more corresponding perspectives of one or more sensors of the ego-machine to one or more transformer NNs of the one or more NNs.
Clause 40. The method of clause 35, wherein the portion of the probabilistic state simulation stack comprises one or more perception networks, one or more state estimation networks, and a navigation policy.
Clause 41. The method of clause 35, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system using or deploying one or more inference microservices; a system that incorporates one or more machine learning models deployed in a service or microservice along with an OS-level virtualization package (e.g., a container); a system implemented at least partially in a data center; or a system implemented at least partially using cloud computing resources.
Clause 42. A system comprising one or more processors to control, within a simulation that is rendered using one or more light transport simulation algorithms, a simulated ego-machine based at least on one or more control actions generated using a control stack, the control stack comprising at least a portion of a probabilistic state simulation stack that includes one or more neural networks.
Clause 43. The system of clause 42, wherein the simulation is generated, at least in part, using a three-dimensional (3D) content collaboration platform for 3D assets.
Clause 44. The system of clause 43, wherein the 3D content collaboration platform for 3D assets uses OpenUSD.
Clause 45. One or more processors comprising processing circuitry to obtain one or more first segments of one or more navigation episodes representing one or more first trajectories of one or more simulated ego-machines.
Clause 46. The one or more processors of clause 45, wherein the processing circuitry is further to obtain, using a navigation policy of a probabilistic state simulation stack, one or more second segments of the one or more navigation episodes representing one or more recovery trajectories of the one or more simulated ego-machines.
Clause 47. The one or more processors of clause 45 or 46, wherein the processing circuitry is further to update one or more neural motion planners based at least on a representation of the one or more recovery trajectories.
Clause 48. The one or more processors of clause 45, 46 or 47, wherein the processing circuitry is further to control one or more operations of an ego-machine based at least on the one or more neural motion planners.
Clause 49. The one or more processors of clause 45, 46, 47 or 48, wherein the processing circuitry is further to initialize at least a portion of the probabilistic state simulation stack based at least on one or more initial segments of the one or more navigation episodes representing one or more real trajectories of one or more physical ego-machines.
Clause 50. The one or more processors of clause 45, 46, 47 or 48, wherein the processing circuitry is further to generate the one or more first trajectories based at least on using the one or more neural motion planners to control the one or more simulated ego-machines in one or more simulation environments.
Clause 51. The one or more processors of clause 45, 46, 47 or 48, wherein the processing circuitry is further to generate the one or more first trajectories based at least on generating one or more control actions using the one or more neural motion planners, and simulating the one or more control actions in a latent space of the probabilistic state simulation stack.
Clause 52. The one or more processors of clause 45, 46, 47 or 48, wherein the processing circuitry is further to generate the one or more first trajectories based at least on executing the one or more neural motion planners with one or more decoders of the probabilistic state simulation stack that generate a reconstructed representation of one or more estimated future scenes in a format that corresponds to one or more inputs of the one or more neural motion planners.
Clause 53. The one or more processors of clause 45, 46, 47 or 48, wherein the processing circuitry is further to generate the one or more first trajectories based at least on adjusting at least one of: one or more control commands or one or more trajectories generated using the navigation policy of the probabilistic state simulation stack.
Clause 54. The one or more processors of clause 45, 46, 47 or 48, wherein the processing circuitry is further to obtain the one or more recovery trajectories based at least on applying a representation of one or more control actions of the ego-machine corresponding to the one or more first trajectories to a scene state estimation neural network of the probabilistic state simulation stack.
Clause 55. The one or more processors of clause 45, 46, 47 or 48, wherein the processing circuitry is further to generate the one or more recovery trajectories based at least on generating a representation of one or more estimated scene states corresponding to the one or more first segments using a generative neural network of the probabilistic state simulation stack and applying the representation of the one or more estimated scene states to the navigation policy.
Clause 56. The one or more processors of clause 45, 46, 47 or 48, wherein the processing circuitry is further to generate the one or more recovery trajectories based at least on generating a representation of one or more estimated scene states corresponding to the one or more first segments using a generative neural network of the probabilistic state simulation stack and applying the representation of the one or more estimated scene states to a history aggregation network of the probabilistic state simulation stack.
Clause 57. The one or more processors of clause 45, 46, 47 or 48, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system using or deploying one or more inference microservices; a system that incorporates one or more machine learning models deployed in a service or microservice along with an OS-level virtualization package (e.g., a container); a system implemented at least partially in a data center; or a system implemented at least partially using cloud computing resources.
Clause 58. A method comprising generating, using a navigation policy of a probabilistic state simulation stack, one or more recovery trajectories of one or more simulated ego-machines.
Clause 59. The method of clause 58, further comprising training one or more neural motion planners based at least on the one or more recovery trajectories.
Clause 60. The method of clause 58 or 59, further comprising controlling one or more operations of an ego-machine based at least on one or more control actions generated using the one or more neural motion planners.
Clause 61. The method of clause 58, 59 or 60, further comprising initializing at least a portion of the probabilistic state simulation stack based at least on one or more real trajectories of one or more physical ego-machines.
Clause 62. The method of clause 58, 59 or 60, further comprising generating one or more initial trajectories of the one or more simulated ego-machines based at least on using the one or more neural motion planners to control the one or more simulated ego-machines in one or more simulation environments.
Clause 63. The method of clause 58, 59 or 60, further comprising generating one or more initial trajectories of the one or more simulated ego-machines based at least on generating one or more initial control actions using the one or more neural motion planners, and simulating the one or more initial control actions in a latent space of the probabilistic state simulation stack.
Clause 64. The method of clause 58, 59 or 60, further comprising generating one or more initial trajectories of the one or more simulated ego-machines based at least on executing the one or more neural motion planners with one or more decoders of the probabilistic state simulation stack that generate a reconstructed representation of one or more estimated future scenes in a format corresponding to one or more inputs of the one or more neural motion planners.
Clause 65. The method of clause 58, 59 or 60, further comprising generating one or more initial trajectories of the one or more simulated ego-machines based at least on adjusting at least one of one or more control commands or one or more trajectories generated using the navigation policy of the probabilistic state simulation stack.
Clause 66. The method of clause 58, 59 or 60, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system using or deploying one or more inference microservices; a system that incorporates one or more machine learning models deployed in a service or microservice along with an OS-level virtualization package (e.g., a container); a system implemented at least partially in a data center; or a system implemented at least partially using cloud computing resources.
Clause 67. A system comprising one or more processors to control, within a simulation that is rendered using one or more light transport simulation algorithms, a simulated ego-machine based at least on one or more control actions generated using one or more neural motion planners, the one or more neural motion planners trained based at least on one or more recovery trajectories generated using a navigation policy of a probabilistic state simulation stack.
Clause 68. The system of clause 67, wherein the simulation is generated, at least in part, using a three-dimensional (3D) content collaboration platform for 3D assets.
Clause 69. The system of clause 68, wherein the 3D content collaboration platform for 3D assets uses OpenUSD.

What is claimed is:

1. One or more processors comprising processing circuitry to:
obtain one or more first segments of one or more navigation episodes representing one or more first trajectories of one or more simulated ego-machines;
obtain, using a navigation policy of a probabilistic state simulation stack, one or more second segments of the one or more navigation episodes representing one or more recovery trajectories of the one or more simulated ego-machines;
update one or more neural motion planners based at least on a representation of the one or more recovery trajectories; and
control one or more operations of an ego-machine based at least on the one or more neural motion planners.

2. The one or more processors of claim 1, wherein the processing circuitry is further to initialize at least a portion of the probabilistic state simulation stack based at least on one or more initial segments of the one or more navigation episodes representing one or more real trajectories of one or more physical ego-machines.

3. The one or more processors of claim 1, wherein the processing circuitry is further to generate the one or more first trajectories based at least on using the one or more neural motion planners to control the one or more simulated ego-machines in one or more simulation environments.

4. The one or more processors of claim 1, wherein the processing circuitry is further to generate the one or more first trajectories based at least on generating one or more control actions using the one or more neural motion planners, and simulating the one or more control actions in a latent space of the probabilistic state simulation stack.

5. The one or more processors of claim 1, wherein the processing circuitry is further to generate the one or more first trajectories based at least on executing the one or more neural motion planners with one or more decoders of the probabilistic state simulation stack that generate a reconstructed representation of one or more estimated future scenes in a format that corresponds to one or more inputs of the one or more neural motion planners.

6. The one or more processors of claim 1, wherein the processing circuitry is further to generate the one or more first trajectories based at least on adjusting at least one of: one or more control commands or one or more trajectories generated using the navigation policy of the probabilistic state simulation stack.

7. The one or more processors of claim 1, wherein the processing circuitry is further to obtain the one or more recovery trajectories based at least on applying a representation of one or more control actions of the ego-machine corresponding to the one or more first trajectories to a scene state estimation neural network of the probabilistic state simulation stack.

8. The one or more processors of claim 1, wherein the processing circuitry is further to generate the one or more recovery trajectories based at least on generating a representation of one or more estimated scene states corresponding to the one or more first segments using a generative neural network of the probabilistic state simulation stack and applying the representation of the one or more estimated scene states to the navigation policy.

9. The one or more processors of claim 1, wherein the processing circuitry is further to generate the one or more recovery trajectories based at least on generating a representation of one or more estimated scene states corresponding to the one or more first segments using a generative neural network of the probabilistic state simulation stack and applying the representation of the one or more estimated scene states to a history aggregation network of the probabilistic state simulation stack.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

11. A method comprising:
generating, using a navigation policy of a probabilistic state simulation stack, one or more recovery trajectories of one or more simulated ego-machines;
training one or more neural motion planners based at least on the one or more recovery trajectories; and
controlling one or more operations of an ego-machine based at least on one or more control actions generated using the one or more neural motion planners.

12. The method of claim 11, further comprising initializing at least a portion of the probabilistic state simulation stack based at least on one or more real trajectories of one or more physical ego-machines.

13. The method of claim 11, further comprising generating one or more initial trajectories of the one or more simulated ego-machines based at least on using the one or more neural motion planners to control the one or more simulated ego-machines in one or more simulation environments.

14. The method of claim 11, further comprising generating one or more initial trajectories of the one or more simulated ego-machines based at least on generating one or more initial control actions using the one or more neural motion planners, and simulating the one or more initial control actions in a latent space of the probabilistic state simulation stack.

15. The method of claim 11, further comprising generating one or more initial trajectories of the one or more simulated ego-machines based at least on executing the one or more neural motion planners with one or more decoders of the probabilistic state simulation stack that generate a reconstructed representation of one or more estimated future scenes in a format corresponding to one or more inputs of the one or more neural motion planners.

16. The method of claim 11, further comprising generating one or more initial trajectories of the one or more simulated ego-machines based at least on adjusting at least one of one or more control commands or one or more trajectories generated using the navigation policy of the probabilistic state simulation stack.

17. The method of claim 11, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

18. A system comprising one or more processors to control, within a simulation that is rendered using one or more light transport simulation algorithms, a simulated ego-machine based at least on one or more control actions generated using one or more neural motion planners, the one or more neural motion planners trained based at least on one or more recovery trajectories generated using a navigation policy of a probabilistic state simulation stack.

19. The system of claim 18, wherein the simulation is generated, at least in part, using a three-dimensional (3D) content collaboration platform for 3D assets.

20. The system of claim 19, wherein the 3D content collaboration platform for 3D assets uses OpenUSD.
